(19) United States
(12) Patent Application Publication
(10) Pub. No.: US 2026/0056538 A1
(43) Pub. Date: Feb. 26, 2026

(54) BUILDING MANAGEMENT SYSTEM WITH MACHINE LEARNING FOR DETECTING ANOMALIES IN VIBRATION DATA SETS

(71) Applicant: Tyco Fire & Security GmbH, Neuhausen am Rheinfall (CH)

(72) Inventors: Santle Camilus Kulandai Samy, Sunnyvale, CA (US); Shweta Kolwalkar, Lithia, FL (US)

(21) Appl. No.: 18/813,955

(22) Filed: Aug. 23, 2024

(51) Int. Cl. G05B 23/02; G06F 18/2415

(52) U.S. Cl. CPC G05B 23/0283; G06F 18/2415; G05B 2223/06

(57) ABSTRACT

A method for correcting abnormal operation of equipment includes obtaining a vibration data set including vibration measurements recorded by one or more vibration sensors while operating the equipment during a time period, obtaining operator comments including observations from an operator characterizing operation of the equipment during the time period, analyzing the vibration data set and the operator comments using one or more machine learning models to identify the operation of the equipment as normal or abnormal, and initiating a corrective action responsive to identifying the operation of the equipment as abnormal. In some embodiments, the method includes generating model reasoning indicating a reason why the operation of the equipment is identified as normal or abnormal by the one or more machine learning models.

### BACKGROUND

The present disclosure relates generally to the field of building equipment for a building and more particularly to analyzing data sets for building equipment using machine learning.

To ensure building equipment for a building is operating correctly, data sets related to operation of the building equipment need to be analyzed. Typically, said analyses are performed by human analysts that are qualified to analyze and detect operational problems related with the building equipment from the data sets. However, training said analysts can be expensive and time consuming. Further, with extremely large data sets, manually parsing through the data sets can be difficult if a limited number of analysts are available.

### SUMMARY

One implementation of the present disclosure is a method for correcting abnormal operation of equipment. The method includes obtaining a vibration data set including vibration measurements recorded by one or more vibration sensors while operating the equipment during a time period, obtaining operator comments including observations from an operator characterizing operation of the equipment during the time period, analyzing the vibration data set and the operator comments using one or more machine learning models to identify the operation of the equipment as normal or abnormal, and initiating a corrective action responsive to identifying the operation of the equipment as abnormal.

In some embodiments, the operator is a human and the operator comments include human observations of the operation of the equipment during the time period.

In some embodiments, analyzing the operator comments includes classifying the operator comments using the one or more machine learning models to generate comment classifications indicating normal or abnormal operation of the equipment as an output of the one or more machine learning models.

In some embodiments, analyzing the operator comments includes receiving a plurality of input labels defining a set of classifications for the operator comments and classifying the operator comments into the set of classifications using the one or more machine learning models.

In some embodiments, analyzing the vibration data set includes performing one or more fast Fourier transforms on the vibration data set to generate one or more fast Fourier transform (FFT) spectra and providing the one or more FFT spectra as input to the one or more machine learning models to generate one or more abnormality probabilities as an output of the one or more machine learning models.

In some embodiments, the method includes training the one or more machine learning models by performing a model training process including obtaining a training set of operator comments including observations from one or more operators characterizing the operation of the equipment or other equipment during a training period prior to the time period, obtaining a training set of analyst assessments classifying the operation of the equipment or the other equipment during the training period into one or more categories, and training the one or more machine learning models to learn a relationship between the training set of operator comments and the training set of analyst assessments.

In some embodiments, the one or more machine learning models include a large language model (LLM). The method may include receiving a user query pertaining to the operation of the equipment during the time period, generating a response to the user query using the LLM, the response including text generated by the LLM based on the vibration data set and the operator comments, and providing the response to the user query to a user device.

In some embodiments, the corrective action includes at least one of scheduling maintenance or replacement for the equipment, generating an abnormal report describing the abnormal operation of the equipment, or disabling the equipment or adjusting the operation of the equipment.

Another implementation of the present disclosure is method for correcting abnormal operation of equipment. The method includes obtaining a vibration data set including vibration measurements recorded by one or more vibration sensors while operating the equipment during a time period, analyzing the vibration data set using one or more machine learning models to identify the operation of the equipment as normal or abnormal, generating model reasoning indicating a reason why the operation of the equipment is identified as normal or abnormal by the one or more machine learning models, and initiating a corrective action responsive to identifying the operation of the equipment as abnormal. The corrective action is based on the model reasoning.

In some embodiments, the method includes providing the vibration data set and the model reasoning to a human analyst, receiving feedback from the human analyst indicating whether the operation of the equipment is normal or abnormal based on the vibration data set and the model reasoning, and initiating the corrective action responsive to the feedback from the human analyst indicating the operation of the equipment is abnormal.

In some embodiments, the method includes using the model reasoning to identify a subset of the vibration data set that caused the one or more machine learning models to identify the operation of the equipment as abnormal and providing the subset of the vibration data set and the model reasoning to a human analyst.

In some embodiments, the vibration data set includes measurements recorded by a plurality of vibration sensors while operating the equipment during the time period and the model reasoning includes an indication of a subset of the vibration data recorded by a particular vibration sensor of the plurality of vibration sensors that caused the one or more machine learning models to identify the operation of the equipment as abnormal.

In some embodiments, analyzing the vibration data set includes performing one or more fast Fourier transforms on the vibration data set to generate one or more fast Fourier transform (FFT) spectra and the model reasoning includes an indication of a subset of the FFT spectra that caused the one or more machine learning models to identify the operation of the equipment as abnormal.

In some embodiments, the method includes generating a report including a particular state of the equipment selected by the one or more machine learning models from a plurality of possible states of the equipment and the model reasoning indicating a reason that caused the one or more machine learning models to select the particular state of the equipment from the plurality of possible states of the equipment.

In some embodiments, generating the model reasoning includes analyzing the vibration data set using a set of rules including abnormality criteria, identifying a particular rule of the set of rules for which the abnormality criteria are satisfied by the vibration data set, and generating a description of the abnormality criteria pertaining to the particular rule.

In some embodiments, the corrective action includes at least one of scheduling maintenance or replacement for the equipment, generating an abnormal report describing the abnormal operation of the equipment, or disabling the equipment or adjusting the operation of the equipment.

Another implementation of the present disclosure is a controller for correcting abnormal operation of equipment. The controller includes one or more processing circuits configured to obtain an operating data set including measurements recorded by one or more sensors while operating the equipment during a time period, obtain operator comments including observations from an operator characterizing operation of the equipment during the time period, analyze the data set and the operator comments using one or more machine learning models to identify the operation of the equipment as normal or abnormal, and initiate a corrective action responsive to identifying the operation of the equipment as abnormal.

In some embodiments, analyzing the operator comments includes classifying the operator comments using the one or more machine learning models to generate comment classifications indicating normal or abnormal operation of the equipment as an output of the one or more machine learning models.

In some embodiments, analyzing the operator comments includes receiving a plurality of input labels defining a set of classifications for the operator comments and classifying the operator comments into the set of classifications using the one or more machine learning models.

In some embodiments, the one or more processing circuits are configured to train the one or more machine learning models by performing a model training process. The model training process may include obtaining a training set of operator comments including observations from one or more operators characterizing the operation of the equipment or other equipment during a training period prior to the time period, obtaining a training set of analyst assessments classifying the operation of the equipment or the other equipment during the training period into one or more categories, and training the one or more machine learning models to learn a relationship between the training set of operator comments and the training set of analyst assessments.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a drawing of a building equipped with a HVAC system, according to some embodiments.

FIG. 2 is a block diagram of a waterside system which can be used to serve the heating or cooling loads of the building of FIG. 1, according to some embodiments.

FIG. 3 is a block diagram of an airside system which can be used to serve the heating or cooling loads of the building of FIG. 1, according to some embodiments.

FIG. 4 is a block diagram of a building management system (BMS) which can be used to monitor and control the building of FIG. 1, according to some embodiments.

FIG. 5 is a block diagram of another BMS which can be used to monitor and control the building of FIG. 1, according to some embodiments.

FIG. 6 is a drawing of a chiller assembly associated with the HVAC system of FIG. 1, according to some embodiments.

FIG. 7 is a block diagram of data set abnormality controller which can be used in any of the systems of FIGS. 1-4 to detect and correct abnormalities in equipment operation, according to some embodiments.

FIG. 8 is a flowchart of a process which can be performed by the data set abnormality controller of FIG. 7 to label data sets as normal or abnormal, according to some embodiments.

FIG. 9 is a block diagram illustrating an operator comment classifier of the data set abnormality controller of FIG. 7 in greater detail when implemented as a fine-tuned large language model (LLM), according to some embodiments.

FIG. 10 is a block diagram illustrating the operator comment classifier of the data set abnormality controller of FIG. 7 in greater detail when implemented as a retrieval augmented generation (RAG) model, according to some embodiments.

FIG. 11 is a drawing of a user interface which can be generated by the data set abnormality controller of FIG. 7 to facilitate classifying operator comments using a few-shot classifier, according to some embodiments.

FIG. 12 is a block diagram illustrating an abnormality identifier of the data set abnormality controller of FIG. 7 in greater detail, according to some embodiments.

FIG. 13 is a graph illustrating a Fast Fourier Transform (FFT) spectrum which can be generated by the data set abnormality controller of FIG. 7 without model reasoning information, according to some embodiments.

FIG. 14 is a graph illustrating another FFT spectrum which can be generated by the data set abnormality controller of FIG. 7 with supplemental model reasoning information, according to some embodiments.

FIG. 15 is a graph illustrating another FFT spectrum which can be generated by the data set abnormality controller of FIG. 7 with supplemental model reasoning information, according to some embodiments.

FIG. 16 is a drawing of an interface which can be generated by the data set abnormality controller of FIG. 7 to facilitate selection of various data sets and provide model reasoning information, according to some embodiments.

FIG. 17 is a drawing of another interface which can be generated by the data set abnormality controller of FIG. 7 to facilitate selection of various data sets and provide model reasoning information, according to some embodiments.

FIG. 18 is a table of equipment status information including machine learning model states and corresponding model reasoning which can be included in an example normal report generated by the data set abnormality controller of FIG. 7, according to some embodiments.

FIG. 19 is a table of equipment status information including machine learning model states and corresponding model reasoning which can be included in an example abnormal report generated by the data set abnormality controller of FIG. 7, according to some embodiments.

FIG. 20 is a flowchart of a process which can be performed by the data set abnormality controller of FIG. 7 to classify operator comments using one or more machine learning models, according to some embodiments.

FIG. 21 is a flowchart of a process which can be performed by the data set abnormality controller of FIG. 7 to generate model reasoning explaining classifications generated by one or more machine learning models, according to some embodiments.

### DETAILED DESCRIPTION

### Overview

Referring generally to the FIGURES, systems and methods for identifying abnormalities in vibration data sets for building equipment is shown, according to some embodiments. The systems and methods discussed herein can collect data from building equipment and analyze the collected data to determine whether the building equipment may be in a fault state. In particular, the systems and methods described herein can incorporate machine learning (ML) models that can automatically analyze and identify possible abnormalities in the vibration data sets.

The ML model can be used to classify vibration data sets as either “normal” or “abnormal.” Normal data sets may indicate associated building equipment is operating as expected and that no faults may be present. However, if the ML model classifies a data set as abnormal, the ML model may have determined that the building equipment has a possibility of being in a fault status. As such, any vibration data sets tagged by the ML model as abnormal can be provided to an analyst for further review. This can ensure that a professional opinion of an individual trained in analyzing vibration data sets can provide feedback regarding whether building equipment associated with abnormal data sets is actually in a fault state.

Using the systems and methods described herein, a workload on analysts can be reduced as some data sets can be automatically flagged as normal. In other words, analysts may not be required to analyze every vibration data set generated by building equipment. These and other features of the systems and methods are described in greater detail below.

### Building HVAC Systems and Building Management Systems

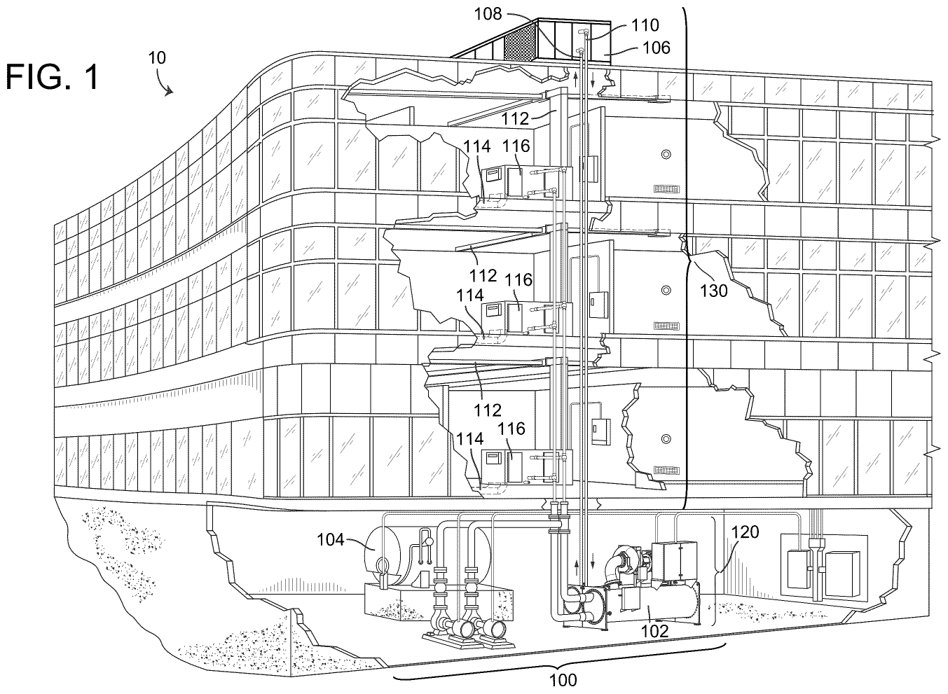

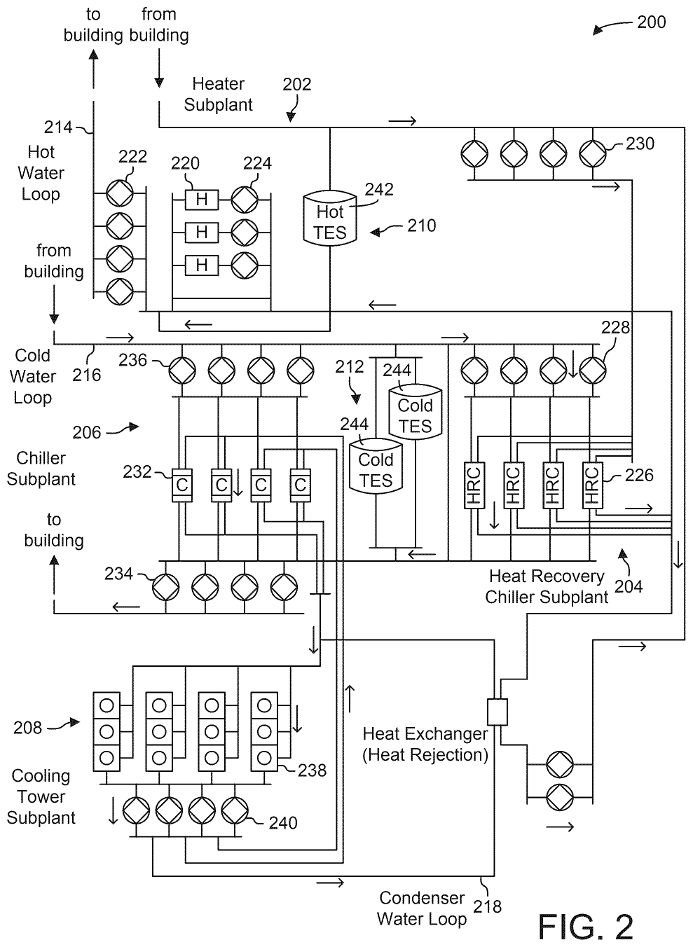

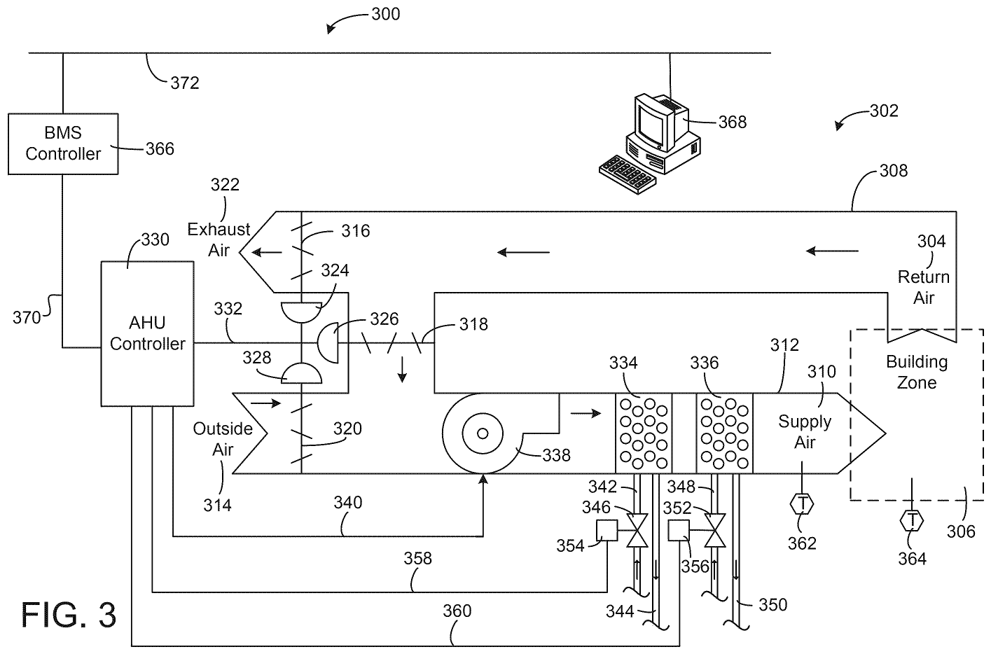

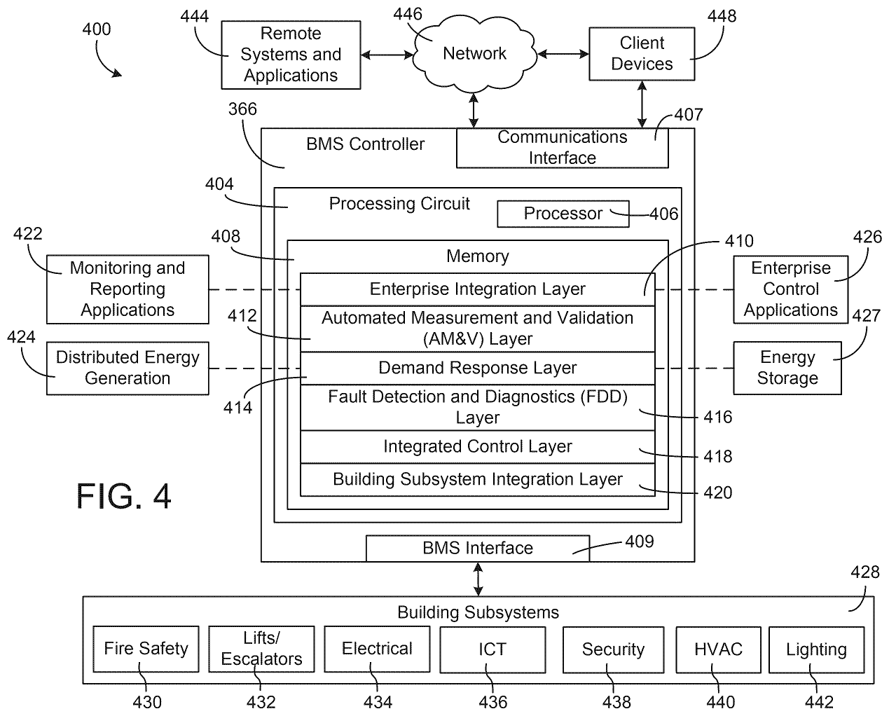

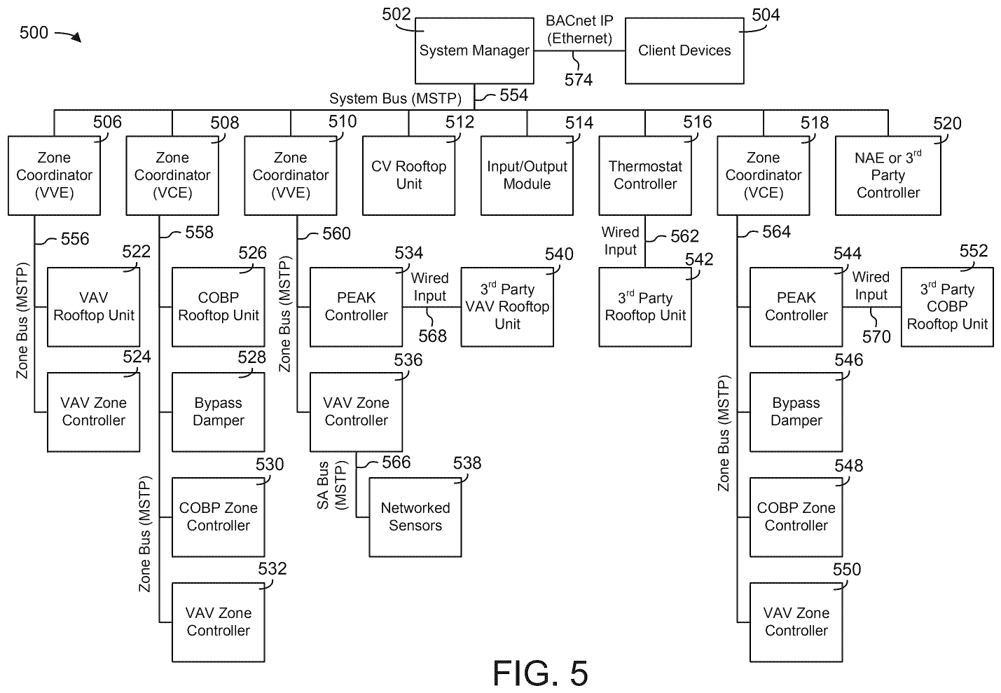

Referring now to FIGS. 1-5, several building management systems (BMS) and HVAC systems in which the systems and methods of the present disclosure can be implemented are shown, according to some embodiments. In brief overview, FIG. 1 shows a building 10 equipped with a HVAC system 100. FIG. 2 is a block diagram of a waterside system 200 which can be used to serve building 10. FIG. 3 is a block diagram of an airside system 300 which can be used to serve building 10. FIG. 4 is a block diagram of a BMS which can be used to monitor and control building 10. FIG. 5 is a block diagram of another BMS which can be used to monitor and control building 10.

### Building and HVAC System

Referring particularly to FIG. 1, a perspective view of a building 10 is shown. Building 10 is served by a BMS. A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof.

The BMS that serves building 10 includes a HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 may provide a heated or chilled fluid to an air handling unit of airside system 130. Airside system 130 may use the heated or chilled fluid to heat or cool an airflow provided to building 10. An exemplary waterside system and airside system which can be used in HVAC system 100 are described in greater detail with reference to FIGS. 2-3.

HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 may place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 may transfer heat between the airflow and the working fluid to provide heating or cooling for the airflow. For example, AHU 106 can include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve setpoint conditions for the building zone.

### Waterside System

Referring now to FIG. 2, a block diagram of a waterside system 200 is shown, according to some embodiments. In various embodiments, waterside system 200 may supplement or replace waterside system 120 in HVAC system 100 or can be implemented separate from HVAC system 100. When implemented in HVAC system 100, waterside system 200 can include a subset of the HVAC devices in HVAC system 100 (e.g., boiler 104, chiller 102, pumps, valves, etc.) and may operate to supply a heated or chilled fluid to AHU 106. The HVAC devices of waterside system 200 can be located within building 10 (e.g., as components of waterside system 120) or at an offsite location such as a central plant.

In FIG. 2, waterside system 200 is shown as a central plant having a plurality of subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve thermal energy loads (e.g., hot water, cold water, heating, cooling, etc.) of a building or campus. For example, heater subplant 202 can be configured to heat water in a hot water loop 214 that circulates the hot water between heater subplant 202 and building 10. Chiller subplant 206 can be configured to chill water in a cold water loop 216 that circulates the cold water between chiller subplant 206 building 10. Heat recovery chiller subplant 204 can be configured to transfer heat from cold water loop 216 to hot water loop 214 to provide additional heating for the hot water and additional cooling for the cold water. Condenser water loop 218 may absorb heat from the cold water in chiller subplant 206 and reject the absorbed heat in cooling tower subplant 208 or transfer the absorbed heat to hot water loop 214. Hot TES subplant 210 and cold TES subplant 212 may store hot and cold thermal energy, respectively, for subsequent use.

Hot water loop 214 and cold water loop 216 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air can be delivered to individual zones of building 10 to serve thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) can be used in place of or in addition to water to serve thermal energy loads. In other embodiments, subplants 202-212 may provide heating and/or cooling directly to the building or campus without requiring an intermediate heat transfer fluid. These and other variations to waterside system 200 are within the teachings of the present disclosure.

Each of subplants 202-212 can include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 may also include one or more pumps or valves configured to control the flow rate of the hot water into or out of hot TES tank 242. Cold TES subplant 212 is shown to include cold TES tanks 244 configured to store the cold water for later use. Cold TES subplant 212 may also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves can be integrated with the pumps or positioned upstream or downstream of the pumps to control the fluid flows in waterside system 200. In various embodiments, waterside system 200 can include more, fewer, or different types of devices and/or subplants based on the particular configuration of waterside system 200 and the types of loads served by waterside system 200.

### Airside System

Referring now to FIG. 3, a block diagram of an airside system 300 is shown, according to some embodiments. In various embodiments, airside system 300 may supplement or replace airside system 130 in HVAC system 100 or can be implemented separate from HVAC system 100. When implemented in HVAC system 100, airside system 300 can include a subset of the HVAC devices in HVAC system 100 (e.g., AHU 106, VAV units 116, ducts 112-114, fans, dampers, etc.) and can be located in or around building 10. Airside system 300 may operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 may receive return air 304 from building zone 306 via return air duct 308 and may deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 can be configured to operate exhaust air damper 316, mixing damper 318, and outside air damper 320 to control an amount of outside air 314 and return air 304 that combine to form supply air 310. Any return air 304 that does not pass through mixing damper 318 can be exhausted from AHU 302 through exhaust damper 316 as exhaust air 322.

Each of dampers 316-320 can be operated by an actuator. For example, exhaust air damper 316 can be operated by actuator 324, mixing damper 318 can be operated by actuator 326, and outside air damper 320 can be operated by actuator 328. Actuators 324-328 may communicate with an AHU controller 330 via a communications link 332. Actuators 324-328 may receive control signals from AHU controller 330 and may provide feedback signals to AHU controller 330. Feedback signals can include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that can be collected, stored, or used by actuators 324-328. AHU controller 330 can be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 can be configured to force supply air 310 through cooling coil 334 and/or heating coil 336 and provide supply air 310 to building zone 306. AHU controller 330 may communicate with fan 338 via communications link 340 to control a flow rate of supply air 310. In some embodiments, AHU controller 330 controls an amount of heating or cooling applied to supply air 310 by modulating a speed of fan 338.

Cooling coil 334 may receive a chilled fluid from waterside system 200 (e.g., from cold water loop 216) via piping 342 and may return the chilled fluid to waterside system 200 via piping 344. Valve 346 can be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BMS controller 366, etc.) to modulate an amount of cooling applied to supply air 310.

Heating coil 336 may receive a heated fluid from waterside system 200 (e.g., from hot water loop 214) via piping 348 and may return the heated fluid to waterside system 200 via piping 350. Valve 352 can be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BMS controller 366, etc.) to modulate an amount of heating applied to supply air 310.

Each of valves 346 and 352 can be controlled by an actuator. For example, valve 346 can be controlled by actuator 354 and valve 352 can be controlled by actuator 356. Actuators 354-356 may communicate with AHU controller 330 via communications links 358-360. Actuators 354-356 may receive control signals from AHU controller 330 and may provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 may also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU controller 330 may control the temperature of supply air 310 and/or building zone 306 by activating or deactivating coils 334-336, adjusting a speed of fan 338, or a combination of both.

Still referring to FIG. 3, airside system 300 is shown to include a building management system (BMS) controller 366 and a client device 368. BMS controller 366 can include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BMS controller 366 may communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 can be separate (as shown in FIG. 3) or integrated. In an integrated implementation, AHU controller 330 can be a software module configured for execution by a processor of BMS controller 366.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 may provide BMS controller 366 with temperature measurements from temperature sensors 362-364, equipment on/off states, equipment operating capacities, and/or any other information that can be used by BMS controller 366 to monitor or control a variable state or condition within building zone 306.

Client device 368 can include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 can be a computer workstation, a client terminal, a remote or local interface, or any other type of user interface device. Client device 368 can be a stationary terminal or a mobile device. For example, client device 368 can be a desktop computer, a computer server with a user interface, a laptop computer, a tablet, a smartphone, a PDA, or any other type of mobile or non-mobile device. Client device 368 may communicate with BMS controller 366 and/or AHU controller 330 via communications link 372.

### Building Management Systems

Referring now to FIG. 4, a block diagram of a building management system (BMS) 400 is shown, according to some embodiments. BMS 400 can be implemented in building 10 to automatically monitor and control various building functions. BMS 400 is shown to include BMS controller 366 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 200 and/or airside system 300, as described with reference to FIGS. 2-3.

Each of building subsystems 428 can include any number of devices, controllers, and connections for completing its individual functions and control activities. HVAC subsystem 440 can include many of the same components as HVAC system 100, as described with reference to FIGS. 1-3. For example, HVAC subsystem 440 can include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 can include any number of light fixtures, ballasts, lighting sensors, dimmers, or other devices configured to controllably adjust the amount of light provided to a building space. Security subsystem 438 can include occupancy sensors, video surveillance cameras, digital video recorders, video processing servers, intrusion detection devices, access control devices and servers, or other security-related devices.

Still referring to FIG. 4, BMS controller 366 is shown to include a communications interface 407 and a BMS interface 409. Interface 407 may facilitate communications between BMS controller 366 and external applications (e.g., monitoring and reporting applications 422, enterprise control applications 426, remote systems and applications 444, applications residing on client devices 448, etc.) for allowing user control, monitoring, and adjustment to BMS controller 366 and/or subsystems 428. Interface 407 may also facilitate communications between BMS controller 366 and client devices 448. BMS interface 409 may facilitate communications between BMS controller 366 and building subsystems 428 (e.g., HVAC, lighting security, lifts, power distribution, business, etc.).

Interfaces 407, 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 409 can be direct (e.g., local wired or wireless communications) or via a communications network 446 (e.g., a WAN, the Internet, a cellular network, etc.). For example, interfaces 407, 409 can include an Ethernet card and port for sending and receiving data via an Ethernet-based communications link or network. In another example, interfaces 407, 409 can include a Wi-Fi transceiver for communicating via a wireless communications network. In another example, one or both of interfaces 407, 409 can include cellular or mobile phone communications transceivers. In one embodiment, communications interface 407 is a power line communications interface and BMS interface 409 is an Ethernet interface. In other embodiments, both communications interface 407 and BMS interface 409 are Ethernet interfaces or are the same Ethernet interface.

Still referring to FIG. 4, BMS controller 366 is shown to include a processing circuit 404 including a processor 406 and memory 408. Processing circuit 404 can be communicably connected to BMS interface 409 and/or communications interface 407 such that processing circuit 404 and the various components thereof can send and receive data via interfaces 407, 409. Processor 406 can be implemented as a general purpose processor, an application specific integrated circuit (ASIC), one or more field programmable gate arrays (FPGAs), a group of processing components, or other suitable electronic processing components.

Memory 408 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 408 can be or include volatile memory or non-volatile memory. Memory 408 can include database components, object code components, script components, or any other type of information structure for supporting the various activities and information structures described in the present application. According to some embodiments, memory 408 is communicably connected to processor 406 via processing circuit 404 and includes computer code for executing (e.g., by processing circuit 404 and/or processor 406) one or more processes described herein.

In some embodiments, BMS controller 366 is implemented within a single computer (e.g., one server, one housing, etc.). In various other embodiments BMS controller 366 can be distributed across multiple servers or computers (e.g., that can exist in distributed locations). Further, while FIG. 4 shows applications 422 and 426 as existing outside of BMS controller 366, in some embodiments, applications 422 and 426 can be hosted within BMS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 can be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 400.

Enterprise integration layer 410 can be configured to serve clients or local applications with information and services to support a variety of enterprise-level applications. For example, enterprise control applications 426 can be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BMS controller 366. In yet other embodiments, enterprise control applications 426 can work with layers 410-420 to optimize building performance (e.g., efficiency, energy use, comfort, or safety) based on inputs received at interface 407 and/or BMS interface 409.

Building subsystem integration layer 420 can be configured to manage communications between BMS controller 366 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translate communications (e.g., sensor data, input signals, output signals, etc.) across a plurality of multi-vendor/multi-protocol systems.

Demand response layer 414 can be configured to optimize resource usage (e.g., electricity use, natural gas use, water use, etc.) and/or the monetary cost of such resource usage in response to satisfy the demand of building 10. The optimization can be based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 may receive inputs from other layers of BMS controller 366 (e.g., building subsystem integration layer 420, integrated control layer 418, etc.). The inputs received from other layers can include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to some embodiments, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models can include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML files, etc.). The policy definitions can be edited or adjusted by a user (e.g., via a graphical user interface) so that the control actions initiated in response to demand inputs can be tailored for the user's application, desired comfort level, particular building equipment, or based on other concerns. For example, the demand response policy definitions can specify which equipment can be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 can be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In some embodiments, integrated control layer 418 includes control logic that uses inputs and outputs from a plurality of building subsystems to provide greater comfort and energy savings relative to the comfort and energy savings that separate subsystems could provide alone. For example, integrated control layer 418 can be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 can be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 can be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 can be configured to provide calculated inputs (e.g., aggregations) to these higher levels based on outputs from more than one building subsystem.

Automated measurement and validation (AM&V) layer 412 can be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 can be based on building system energy models and/or equipment models for individual BMS devices or subsystems. For example, AM&V layer 412 may compare a model-predicted output with an actual output from building subsystems 428 to determine an accuracy of the model.

Fault detection and diagnostics (FDD) layer 416 can be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, or from another data source. FDD layer 416 may automatically diagnose and respond to detected faults. The responses to detected or diagnosed faults can include providing an alert message to a user, a maintenance scheduling system, or a control algorithm configured to attempt to repair the fault or to work-around the fault.

FDD layer 416 can be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418 which executes control strategies and policies in response to the received fault events. According to some embodiments, FDD layer 416 (or a policy executed by an integrated control engine or business rules engine) may shut-down systems or direct control activities around faulty devices or systems to reduce energy waste, extend equipment life, or assure proper control response.

FDD layer 416 can be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BMS 400 and the various components thereof. The data generated by building subsystems 428 can include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

Referring now to FIG. 5, a block diagram of another building management system (BMS) 500 is shown, according to some embodiments. BMS 500 can be used to monitor and control the devices of HVAC system 100, waterside system 200, airside system 300, building subsystems 428, as well as other types of BMS devices (e.g., lighting equipment, security equipment, etc.) and/or HVAC equipment.

BMS 500 provides a system architecture that facilitates automatic equipment discovery and equipment model distribution. Equipment discovery can occur on multiple levels of BMS 500 across multiple different communications busses (e.g., a system bus 554, zone buses 556-560 and 564, sensor/actuator bus 566, etc.) and across multiple different communications protocols. In some embodiments, equipment discovery is accomplished using active node tables, which provide status information for devices connected to each communications bus. For example, each communications bus can be monitored for new devices by monitoring the corresponding active node table for new nodes. When a new device is detected, BMS 500 can begin interacting with the new device (e.g., sending control signals, using data from the device) without user interaction.

Some devices in BMS 500 present themselves to the network using equipment models. An equipment model defines equipment object attributes, view definitions, schedules, trends, and the associated BACnet value objects (e.g., analog value, binary value, multistate value, etc.) that are used for integration with other systems. Some devices in BMS 500 store their own equipment models. Other devices in BMS 500 have equipment models stored externally (e.g., within other devices). For example, a zone coordinator 508 can store the equipment model for a bypass damper 528. In some embodiments, zone coordinator 508 automatically creates the equipment model for bypass damper 528 or other devices on zone bus 558. Other zone coordinators can also create equipment models for devices connected to their zone busses. The equipment model for a device can be created automatically based on the types of data points exposed by the device on the zone bus, device type, and/or other device attributes. Several examples of automatic equipment discovery and equipment model distribution are discussed in greater detail below.

Still referring to FIG. 5, BMS 500 is shown to include a system manager 502; several zone coordinators 506, 508, 510 and 518; and several zone controllers 524, 530, 532, 536, 548, and 550. System manager 502 can monitor data points in BMS 500 and report monitored variables to various monitoring and/or control applications. System manager 502 can communicate with client devices 504 (e.g., user devices, desktop computers, laptop computers, mobile devices, etc.) via a data communications link 574 (e.g., BACnet IP, Ethernet, wired or wireless communications, etc.). System manager 502 can provide a user interface to client devices 504 via data communications link 574. The user interface may allow users to monitor and/or control BMS 500 via client devices 504.

In some embodiments, system manager 502 is connected with zone coordinators 506-510 and 518 via a system bus 554. System manager 502 can be configured to communicate with zone coordinators 506-510 and 518 via system bus 554 using a master-slave token passing (MSTP) protocol or any other communications protocol. System bus 554 can also connect system manager 502 with other devices such as a constant volume (CV) rooftop unit (RTU) 512, an input/output module (IOM) 514, a thermostat controller 516 (e.g., a TEC5000 series thermostat controller), and a network automation engine (NAE) or third-party controller 520. RTU 512 can be configured to communicate directly with system manager 502 and can be connected directly to system bus 554. Other RTUs can communicate with system manager 502 via an intermediate device. For example, a wired input 562 can connect a third-party RTU 542 to thermostat controller 516, which connects to system bus 554.

System manager 502 can provide a user interface for any device containing an equipment model. Devices such as zone coordinators 506-510 and 518 and thermostat controller 516 can provide their equipment models to system manager 502 via system bus 554. In some embodiments, system manager 502 automatically creates equipment models for connected devices that do not contain an equipment model (e.g., IOM 514, third party controller 520, etc.). For example, system manager 502 can create an equipment model for any device that responds to a device tree request. The equipment models created by system manager 502 can be stored within system manager 502. System manager 502 can then provide a user interface for devices that do not contain their own equipment models using the equipment models created by system manager 502. In some embodiments, system manager 502 stores a view definition for each type of equipment connected via system bus 554 and uses the stored view definition to generate a user interface for the equipment.

Each zone coordinator 506-510 and 518 can be connected with one or more of zone controllers 524, 530-532, 536, and 548-550 via zone buses 556, 558, 560, and 564. Zone coordinators 506-510 and 518 can communicate with zone controllers 524, 530-532, 536, and 548-550 via zone busses 556-560 and 564 using a MSTP protocol or any other communications protocol. Zone busses 556-560 and 564 can also connect zone coordinators 506-510 and 518 with other types of devices such as variable air volume (VAV) RTUs 522 and 540, changeover bypass (COBP) RTUs 526 and 552, bypass dampers 528 and 546, and PEAK controllers 534 and 544.

Zone coordinators 506-510 and 518 can be configured to monitor and command various zoning systems. In some embodiments, each zone coordinator 506-510 and 518 monitors and commands a separate zoning system and is connected to the zoning system via a separate zone bus. For example, zone coordinator 506 can be connected to VAV RTU 522 and zone controller 524 via zone bus 556. Zone coordinator 508 can be connected to COBP RTU 526, bypass damper 528, COBP zone controller 530, and VAV zone controller 532 via zone bus 558. Zone coordinator 510 can be connected to PEAK controller 534 and VAV zone controller 536 via zone bus 560. Zone coordinator 518 can be connected to PEAK controller 544, bypass damper 546, COBP zone controller 548, and VAV zone controller 550 via zone bus 564.

A single model of zone coordinator 506-510 and 518 can be configured to handle multiple different types of zoning systems (e.g., a VAV zoning system, a COBP zoning system, etc.). Each zoning system can include a RTU, one or more zone controllers, and/or a bypass damper. For example, zone coordinators 506 and 510 are shown as Verasys VAV engines (VVEs) connected to VAV RTUs 522 and 540, respectively. Zone coordinator 506 is connected directly to VAV RTU 522 via zone bus 556, whereas zone coordinator 510 is connected to a third-party VAV RTU 540 via a wired input 568 provided to PEAK controller 534. Zone coordinators 508 and 518 are shown as Verasys COBP engines (VCEs) connected to COBP RTUs 526 and 552, respectively. Zone coordinator 508 is connected directly to COBP RTU 526 via zone bus 558, whereas zone coordinator 518 is connected to a third-party COBP RTU 552 via a wired input 570 provided to PEAK controller 544.

Zone controllers 524, 530-532, 536, and 548-550 can communicate with individual BMS devices (e.g., sensors, actuators, etc.) via sensor/actuator (SA) busses. For example, VAV zone controller 536 is shown connected to networked sensors 538 via SA bus 566. Zone controller 536 can communicate with networked sensors 538 using a MSTP protocol or any other communications protocol. Although only one SA bus 566 is shown in FIG. 5, it should be understood that each zone controller 524, 530-532, 536, and 548-550 can be connected to a different SA bus. Each SA bus can connect a zone controller with various sensors (e.g., temperature sensors, humidity sensors, pressure sensors, light sensors, occupancy sensors, etc.), actuators (e.g., damper actuators, valve actuators, etc.) and/or other types of controllable equipment (e.g., chillers, heaters, fans, pumps, etc.).

Each zone controller 524, 530-532, 536, and 548-550 can be configured to monitor and control a different building zone. Zone controllers 524, 530-532, 536, and 548-550 can use the inputs and outputs provided via their SA busses to monitor and control various building zones. For example, a zone controller 536 can use a temperature input received from networked sensors 538 via SA bus 566 (e.g., a measured temperature of a building zone) as feedback in a temperature control algorithm. Zone controllers 524, 530-532, 536, and 548-550 can use various types of control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control a variable state or condition (e.g., temperature, humidity, airflow, lighting, etc.) in or around building 10.

### Chiller Assembly

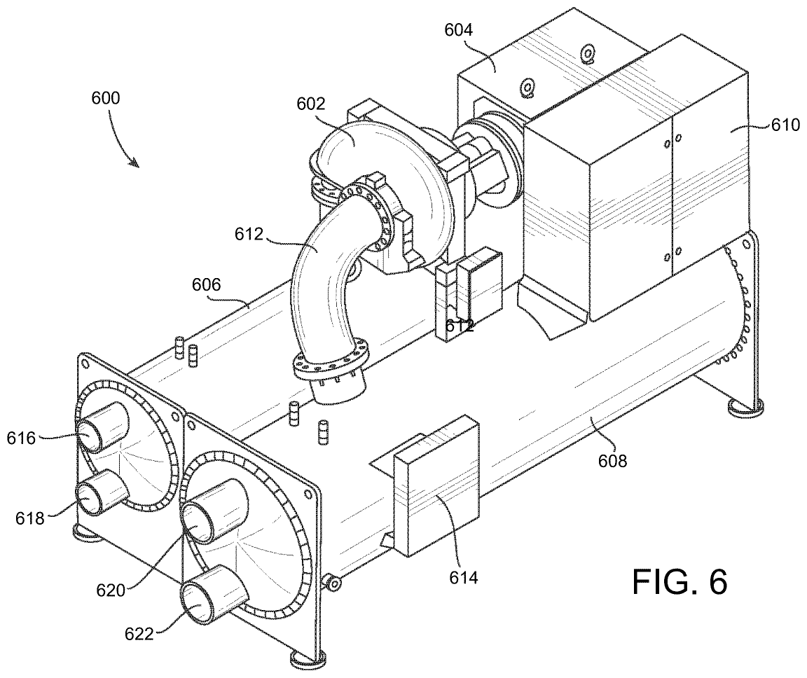

Turning now to FIG. 6, an example implementation of a chiller assembly 600 is shown, according to some embodiments. Chiller assembly 600 may be identical or nearly identical to chiller 102 described above. Chiller assembly 600 is shown to include a compressor 602 driven by a motor 604, a condenser 606, and an evaporator 608. A refrigerant can be circulated through chiller assembly 600 in a vapor compression cycle or an absorption refrigeration cycle. The refrigerant can be a low pressure refrigerant with an operating pressure less than 400 kPa, for example. Chiller assembly 600 can also include a control panel 614 configured to control operation of the vapor compression cycle within chiller assembly 600. Control panel 614 may be connected to a variety of sensors (e.g., pressure sensors, temperature sensors) and an electronic network (e.g., network 446) in order to communicate a variety of data related to maintenance, analytics, performance, etc. The sensors may additionally or alternatively communicate directly with a controller (e.g., BMS controller 366) and/or BMS 400.

Motor 604 can be powered by a variable speed drive (VSD) 610. In some embodiments, VSD 610 receives alternating current (AC) power having a fixed line voltage and fixed line frequency from an AC power source (not shown) and provides power having a variable voltage and frequency to motor 604. Motor 604 can be any type of electric motor that can be powered by VSD 610. For example, motor 604 can be a high speed induction motor. Compressor 602 can be driven by motor 604 to compress a refrigerant vapor received from evaporator 608 through a suction line 612. For example, compressor 602 can include an impeller comprising a plurality of blades configured to rotate at a high speed in order to compress refrigerant vapor. Compressor 602 may then deliver compressed refrigerant vapor to condenser 606 through a discharge line. Compressor 602 can be a centrifugal compressor, a screw compressor, a scroll compressor, a turbine compressor, or any other type of suitable compressor.

Evaporator 608 can include an internal tube bundle (not shown), a supply line 620, and a return line 622 for supplying and removing a process fluid to the internal tube bundle. Supply line 620 and return line 622 can be in fluid communication with a component within an HVAC system (e.g., air handler 106) via conduits that circulate the process fluid. In some embodiments, the process fluid is a chilled liquid for cooling a building and can be, but is not limited to, water, ethylene glycol, calcium chloride brine, sodium chloride brine, or any other suitable liquid. Evaporator 608 can be configured to lower the temperature of the process fluid as the process fluid passes through the tube bundle of evaporator 608 and exchanges heat with the refrigerant. Refrigerant vapor is formed in evaporator 608 by the refrigerant liquid delivered to the evaporator 608 exchanging heat with the process fluid and undergoing a phase change to refrigerant vapor.

Refrigerant vapor delivered by compressor 602 to condenser 606 transfers heat to a fluid. Refrigerant vapor condenses to refrigerant liquid in condenser 606 as a result of heat transfer with the fluid. The refrigerant liquid from condenser 606 can flow through an expansion device and be returned to evaporator 608 to complete the refrigerant cycle of the chiller assembly 600. Condenser 606 includes a supply line 616 and a return line 618 for circulating fluid between the condenser 606 and an external component of the HVAC system (e.g., a cooling tower). Fluid supplied to condenser 606 via return line 618 can exchange heat with the refrigerant in condenser 606 and can be removed from the condenser 606 via supply line 616 to complete the cycle. The fluid circulating through the condenser 606 can be water or any other suitable liquid.

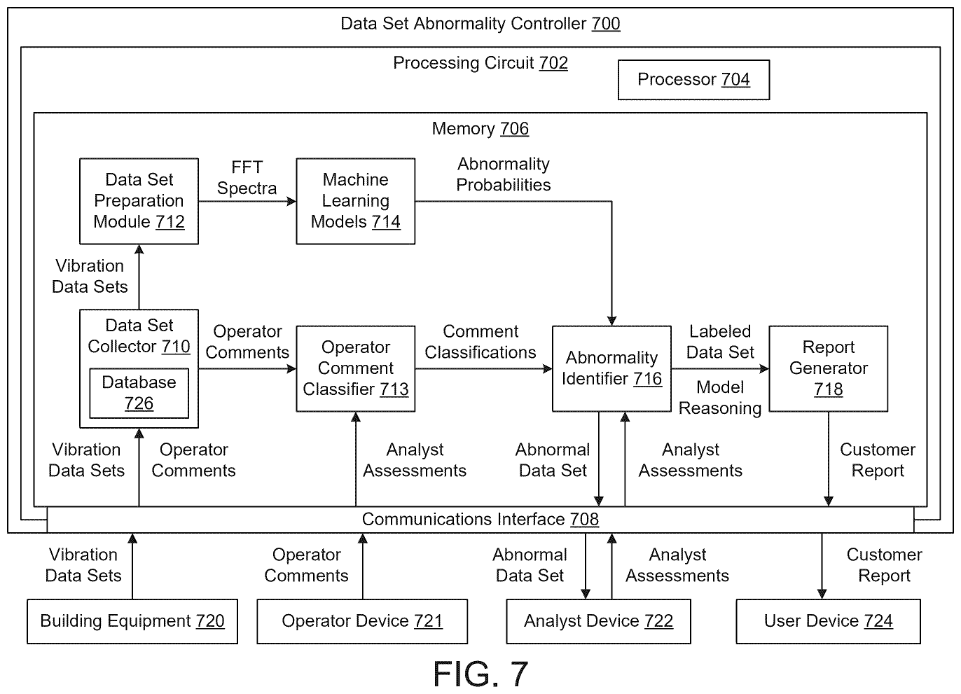

In some embodiments, chiller assembly 600 illustrates an example building device that can be monitored for vibrational data. Sensors can be mounted to an external casing of chiller assembly 600. Specifically, sensors may be mounted at bearing locations across a drive line of chiller assembly 600. In this case, the bearing locations may be locations of chiller assembly 600 that experience transfer of forces to the external casing of chiller assembly 600. Sensors can be mounted to measure three-dimensional vibrational data of chiller assembly 600. In other words, the sensors can measure how chiller assembly 600 and/or associated components vibrate in three-dimensional space. Purely for sake of example, sensors for measuring vibrational data may be mounted at locations of chiller assembly 600 such as motor 604, VSD 610, compressor 602, suction line 612, etc. In this way, vibrational data can be collected across various locations of chiller assembly 600. Vibrational data and processing associated therewith is described in greater detail below with reference to FIGS. 7-11.

### Detecting Anomalies in Vibration Data

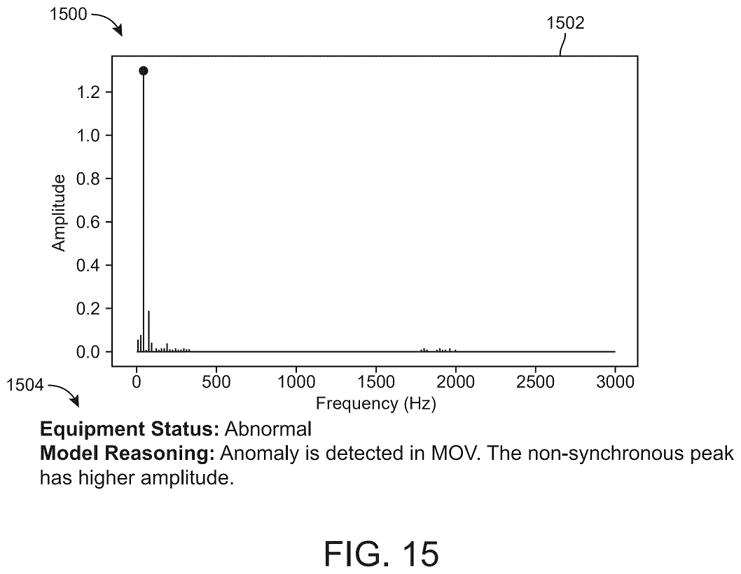

Referring generally to FIGS. 7-21, systems and methods for analyzing data sets and identifying faulty building equipment using machine learning are shown, according to some embodiments. In some embodiments, the systems and methods described herein can be used to analyzing vibration data sets for building equipment that can provide an overall indication of whether specific building devices are functioning properly. However, it should be appreciated that similar methodologies described herein can be applied to data sets other than vibration data sets. As such, vibration data sets are provided for purposes of example and are not intended to be limiting on the present disclosure. Other types of data sets are contemplated in the present disclosure as well. Further, it should be appreciated that analyzing vibration data sets for building equipment as described herein is provided for sake of example. Analysis of vibration data sets as described herein can be applied to any sort of equipment and is not intended to be limited to building equipment. For example, vibration data sets can be gathered and analyzed for equipment such as photolithography equipment, microelectronics manufacturing equipment or other manufacturing equipment, etc. In this way, vibration data sets can be analyzed to detect faults and/or other problems in various types of equipment.

Vibration analysis is an important tool in identifying mechanical issues in building equipment such as chillers, fans, pumps, etc. In some embodiments vibrational data is collected on-site by mounting sensors on building equipment. For example, sensors may be placed on a casing of a machine at bearing locations across a machine drive line. Vibrational sensors may be placed at bearings as bearings may be a primary point where forces are transferred from internal components to an external casing. Sensors may be placed across multiple bearing points (e.g., 3 points, 4 points, 10 points, etc.) on a building device and can monitor/gather vibrational data across 3-dimensioanl spatial coordinates (i.e., X axis, Y axis, and Z axis). The vibrational data can be assessed to identify potential issues so they can be corrected before serious damage to the building equipment occurs. While rules derived from years of domain knowledge may automate a portion of the analysis, said rules are incomplete and cannot confidently rule out a possibility of building faults, and therefore human inspection of all datasets may be required in traditional systems.

Due to modern advances in building equipment, most building equipment is highly reliable and experiences faults relatively infrequently. As such, a large amount of vibration data sets associated with building equipment may indicate the building equipment is operating as normal. Requiring analysts to manually parse through data sets that have no suspicion of indicating faults can be time-consuming and wasteful for the analysts and a company hiring said analysts. As such, a machine learning model can be utilized to qualify data sets into categories indicating whether the data sets appear to indicate normal operation or appear to indicate an issue with building equipment that should be addressed in further detail.

As a size of collected vibration data sets increases, human analysis of each data set may become more and more unviable. As such, a machine learning (ML) model can be utilized to reduce an amount of data sets required for human analysis. By automating at least part of the analysis process, a burden on analysts can be reduced and money can be saved for a company (e.g., by requiring fewer analysts) among other benefits.

When analyzing data sets for building equipment, it may be important for the ML model to generate reports (i.e., results of automated analyses) that do not let any data set be flagged as “normal” (i.e., no issue is present) when the data set is actually “abnormal” (i.e., a problem with the building equipment is present). In other words, anomaly detection performed by the ML model may be configured such that any data sets that have even a slight change of being abnormal may be flagged for further analysis by an analyst. In this way, a number of false negatives can be reduced/eliminated to ensure that no critical faults are missed by the ML model and are accidentally flagged as normal.

Referring now to FIG. 7, a block diagram of data set abnormality controller 700 is shown, according to some embodiments. Data set abnormality controller 700 can be configured to analyze vibration data sets (or other types of data sets) to determine if the data sets include abnormalities that may be indicative of problems with building equipment 720 (e.g., sensors, chillers, boilers, fans, pumps, lighting equipment, etc.). In some embodiments, data set abnormality controller 700 can use machine learning (ML) models 714 to qualify data sets as either normal or abnormal such that appropriate corrective action can be taken to repair or replace any faulty building equipment 720 and abnormal data sets can be further analyzed by an analyst. As described in greater detail below, data set abnormality controller 700 can provide various benefits for a building system and employees associated therewith. In particular, by implementing ML models 714 for qualifying data sets, an efficiency of analysts that analyze vibrational data can be increased and a number of data sets the analysts are required to evaluate can decrease.

In some embodiments, data set abnormality controller 700 can be implemented as a component of a building management system (BMS) such as BMS 400 or BMS 500 as described with reference to FIGS. 4-5 (e.g., as part of FDD layer 416). Data set abnormality controller 700 can be located on-site (e.g., in the same building or campus as building equipment 720, within building 10, etc.) or off-site (e.g., at a remote location, a remote monitoring system, etc.) in various embodiments. For example, data set abnormality controller 700 can be implemented as part of a centralized controller for the building or site (e.g., as part of BMS controller 366 or system manager 502) or as part of an edge device (e.g., a field controller, a gateway, a device of controllable equipment, etc.). In some embodiments, data set abnormality controller 700 is implemented as part of a cloud-hosted suite of building management applications or services which communicates with building equipment 720 via a communications network such as the internet, a cellular network, a WAN, etc. It is contemplated that data set abnormality controller 700 can be implemented in any location and can be centralized or distributed in various architectures. For example, some components of data set abnormality controller 700 may be located on-site, whereas other components of data set abnormality controller 700 may be located off-site in a distributed implementation. In some embodiments, various components of data set abnormality controller 700 can be distributed across multiple on-site or off-site devices (e.g., a centralized BMS, edge devices or gateways, supervisory or field controllers, etc.). The location or locations of data set abnormality controller 700 is not important and can be varied to accommodate a variety of implementation architectures.

Data set abnormality controller 700 is shown to include a communications interface 708 and a processing circuit 702. Communications interface 708 may include wired or wireless interfaces (e.g., jacks, antennas, transmitters, receivers, transceivers, wire terminals, etc.) for conducting data communications with various systems, devices, or networks. For example, communications interface 708 may include an Ethernet card and port for sending and receiving data via an Ethernet-based communications network and/or a Wi-Fi transceiver for communicating via a wireless communications network. Communications interface 708 may be configured to communicate via local area networks or wide area networks (e.g., the Internet, a building WAN, etc.) and may use a variety of communications protocols (e.g., BACnet, IP, LON, etc.). Communications interface 708 may be a network interface configured to facilitate electronic data communications between data set abnormality controller 700 and various external systems or devices (e.g., building equipment 720, analyst device 722, user device 724, etc.). For example, data set abnormality controller 700 may receive vibration data sets from building equipment 720 via communications interface 708.

Processing circuit 702 is shown to include a processor 704 and memory 706. Processor 704 may be a general purpose or specific purpose processor, an application specific integrated circuit (ASIC), one or more field programmable gate arrays (FPGAs), a group of processing components, or other suitable processing components. Processor 704 may be configured to execute computer code or instructions stored in memory 706 or received from other computer readable media (e.g., CDROM, network storage, a remote server, etc.).

Memory 706 may include one or more devices (e.g., memory units, memory devices, storage devices, etc.) for storing data and/or computer code for completing and/or facilitating the various processes described in the present disclosure. Memory 706 may include random access memory (RAM), read-only memory (ROM), hard drive storage, temporary storage, non-volatile memory, flash memory, optical memory, or any other suitable memory for storing software objects and/or computer instructions. Memory 706 may include database components, object code components, script components, or any other type of information structure for supporting the various activities and information structures described in the present disclosure. Memory 706 may be communicably connected to processor 704 via processing circuit 702 and may include computer code for executing (e.g., by processor 704) one or more processes described herein. In some embodiments, one or more components of memory 706 are part of a singular component. However, each component of memory 706 is shown independently for ease of explanation.

Memory 706 is shown to include a data set collector 710. Data set collector 710 can be configured to receive vibration data sets from building equipment 720 (e.g., via communications interface 708). Building equipment 720 can include any equipment that operates to affect a variable state or condition of a building and/or other space. Specifically, building equipment 720 can operate to affect environmental conditions of the building and/or other space. As such, building equipment 720 may include, for example, chillers, boilers, air handling units, fire suppression equipment, etc. In some embodiments, building equipment 720 includes some and/or all of the subsystems of building subsystems 428 as described with reference to FIG. 4. In some embodiments, building equipment 720 include various types of sensors (e.g., vibration sensors, temperature sensors, pressure sensors, etc.) configured to monitor the performance of building equipment 720. Such sensors can be affixed to devices of building equipment 720 and/or otherwise capable of obtaining measurements of building equipment 720.

A typical vibration data set may include timewave data indicating acceleration over time. In some embodiments, the timewave data is collected by accelerometers on different physical points on a building device. For example, a data set for a chiller may include vibration signals collected from locations of the chiller such as a compressor, an off-end motor, and a drive-end motor. In this example, vibration data can be collected in three sensor orientations (e.g., X, Y, and Z directions of three-dimensional space), thereby generating 9 timewaves in total. Each of the timewaves can be evaluated by a ML model (or multiple ML models) for accurate anomaly detection. This can ensure that if equipment faults are only detectable at certain locations and/or orientations of the device, the faults can nonetheless be detected.

In some embodiments, the vibration data sets also includes information such as machine metadata, machine operating conditions, one or more time waveforms, relevant machine specifications (e.g., a line frequency, a number of impeller blades, a gear ratio), etc. Additional information other than raw vibration signals can help the ML model in determining frequencies and ranges where vibration signals may be expected. Various types of sensor data including vibration data sets and other types of sensor data are described in detail in U.S. patent application Ser. No. 15/993,331 filed May 30, 2018, U.S. patent application Ser. No. 16/413,892 filed May 16, 2019, and U.S. patent application Ser. No. 16/658,822 filed Oct. 21, 2019, the entire disclosure of each of which is incorporated by reference herein. In some embodiments, the systems and methods described herein can be implemented in combination with the systems and methods described in the incorporated patent applications.

Data set collector 710 may also receive operator comments from an operator device 721. Operator device 721 may include any type of user device capable of receiving input from an operator (e.g., a human, a service technician, a maintenance worker, an equipment installer, a building owner, a building occupant, etc.) regarding the observed performance of building equipment 720. Examples of operator devices 721 include a smartphone, a laptop computer, a tablet, a desktop computer, or any other device which can be used to obtain operator comments from the operator. The operator comments may include the operator's observations, notes, assessments, or other comments from the operator indicating the operator's personal assessment of building equipment 720 (e.g., upon inspection, upon observation, etc.). Examples of operator comments include comments such as “motor sounds rough when running,” “technician has noted noise after a few minutes of machine operation,” “extremely noisy,” “motor was shaking extremely,” “noted motor running with unpleasant humming noise,” “everything looks okay,” “new coupling,” “chiller is leaking fluid,” “surface hot to the touch,” or any other comment the operator chooses to provide regarding building equipment 720.

Operator comments can be provided in a variety of different formats or modalities (e.g., text, speech, audio, image, and/or video). Operator comments can include unstructured data or structured data. Unstructured data may include data that does not conform to a predetermined format or data that conforms to a plurality of different predetermined formats. For example, the unstructured data may include freeform data that does not conform to any particular format (e.g., freeform text, natural language text, or other freeform data) and/or data that conforms to a combination of different predetermined formats (e.g., a text format, a speech format, an audio format, an image format, a video format, a data file format, etc.). In some embodiments, the unstructured data includes multi-modal data provided by different types of sensory devices (e.g., an audio capture device, a video capture device, an image capture device, a text capture device, a handwriting capture device, etc.). Conversely, structured data may include data that conforms to a predetermined format. In some embodiments, structured data includes data that is labeled with or assigned to one or more predetermined fields or identifiers. For example, the structured data may conform to a structured data format including one or more predetermined fields or locations and one or more predetermined labels or identifiers characterizing the one or more predetermined fields or locations. In some embodiments, operator comments can include any of the various types of service data, service reports, and/or data sources described in U.S. patent application Ser. No. 18/633,068 filed Apr. 11, 2024, the entire disclosure of which is incorporated by reference herein.

In some embodiments, data set collector 710 stores collected vibration data sets and/or the operator comments in a database 726. Database 726 is shown as a component of data set collector 710 for ease of explanation. Database 726 may be a separate component of data set abnormality controller 700 and/or may be separate from data set abnormality controller 700 altogether. For example, database 726 may be hosted by a cloud provider and hosted on a cloud computation system that data set abnormality controller 700 can communicate with. In this case, data set collector 710 may transmit and receive vibration data sets and operator comments to and from the cloud computation system via communications interface 708. In any case, by storing vibration data sets and operator comments in database 726, the vibration data sets and operator comments can be saved and later used for other processes such as retraining an ML model for detecting abnormalities, displaying vibration data sets to analysts, etc.

Data set collector 710 can be configured to associate the vibration data sets with corresponding operator comments and store such associations in database 726. Data set collector 710 can identify the particular sensor or device of building equipment 720 that provides each of the vibration data sets and store an indication of the source of the vibration data set along with the vibration data in database 726. Data set collector 710 can also identify the particular sensor or device of building equipment 720 described by each of the operator comments and store such information along with the operator comments in database 726. In various embodiments, data set collector 710 can identify the particular sensor or device of building equipment 720 described by each of the operator comments based on information included in the operator comments themselves or auxiliary information or metadata included with the operator comments. Such information may include the locations of operator devices 721 (e.g., GPS coordinates, triangulated locations, etc.) when the operator comments are entered relative to the locations of building equipment 720 (e.g., associating operator comments with the nearest building equipment 720), selections made by the operator when entering the operator comments (e.g., selecting particular devices of building equipment 720), information extracted from work orders or maintenance tasks assigned to the operator during a time period when the operator comments are entered (e.g., a work order specifying the operator is assigned to inspect a particular device of building equipment 720 at the time the operator comments are entered), or any other association or link which can be used to match or associate a particular operator comment with a corresponding device of building equipment 720. In some embodiments, data set collector 710 is configured to use any of the techniques described in U.S. patent application Ser. No. 18/633,068 filed Apr. 11, 2024, the entire disclosure of which is incorporated by reference herein, to associate the operator comments with corresponding building equipment 720, vibration data sets, and/or other data sources. See the section of the '068 application titled “AI-Based Coupling of Unstructured Service Data to Other Input/Output Data Sources and Analytics.”

Data set collector 710 can provide the vibration data sets to data set preparation module 712. Data set preparation module 712 can prepare vibration data sets for being used as input to ML models 714. Dependent on a format of ML models 714, some ML models of ML models 714 may require vibrational data to be presented as input in a format other than raw vibration signals. As such, data set preparation module 712 can manipulate vibration data sets received from data set collector 710 to ensure data provided to ML models 714 is in a proper format and includes useful information.

In some embodiments, data set preparation module 712 performs fast Fourier transforms (FFTs) for each timewave associated with a vibration data set. The FFTs can represent the timewaves in a frequency domain such that the vibration data sets can be more easily processed by ML models 714. In some embodiments, each FFT for a timewave is calculated with a certain frequency range and resolution. In this way, specific equipment abnormalities can be identified and resolved. For example, motor shaft issues may only be detectable at lower frequencies and gear set faults may only be detectable at high frequencies. As such, data set preparation module 712 can compute an FFT that captures low frequency ranges to detect motor shaft issues and can compute an FFT that captures high frequency ranges at which the gear set faults are detectable.

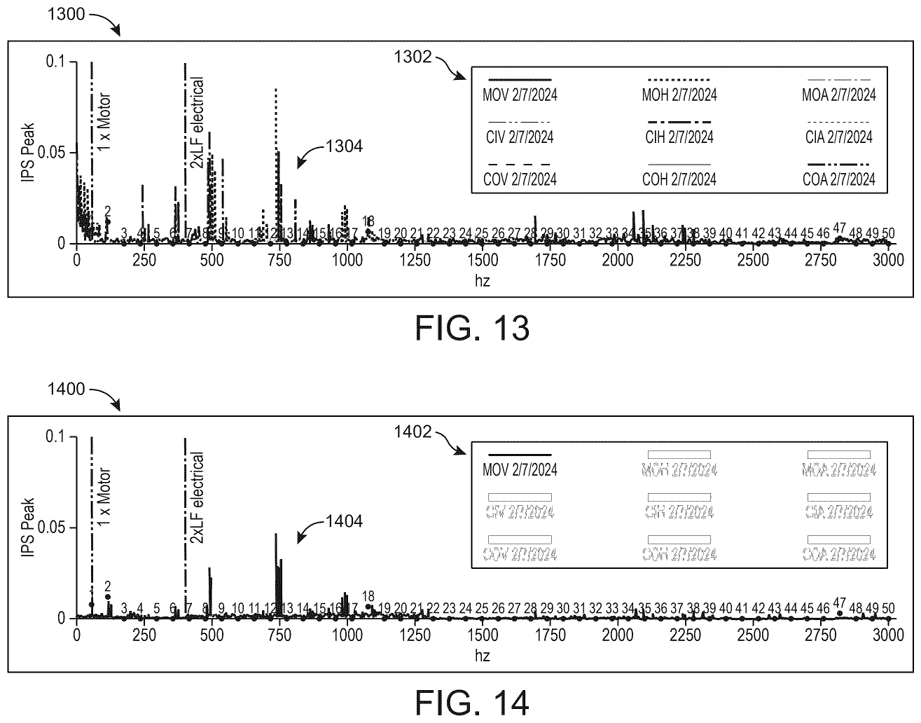

As a result of performing the FFTs, FFT spectra can be generated by data set preparation module 712 for a vibration data set. An FFT spectrum may include compiled results of individual FFTs performed on the vibration data set. Each FFT spectrum may be specific to a particular range of frequencies and resolution. The particular range of frequencies and resolution for a particular FFT spectra can define a “type” of the FFT spectra. The FFT spectra can be provided to machine learning models 714 as inputs. Examples of FFT processes which can be performed by data set preparation module 712 are described in greater detail in U.S. patent application Ser. No. 16/658,822 filed Oct. 21, 2019, the entire disclosure of which is incorporated by reference herein. Examples of FFT spectra that can be generated by data set preparation module 712 are described in greater detail with reference to FIGS. 13-14.

It should be noted that FFTs are given as an example of data preparation that can be performed to prepare vibration data sets to be inputted to ML models 714. Computing FFTs for individual timewaves and using FFT spectra as input to ML models 714 can be useful if a large amount of historical data is unavailable. In some embodiments, other approaches for data preparation are utilized. For example, ML models 714, as described in detail below, may utilize time domain data as input. In this case, data set preparation module 712 can manipulate vibration data sets to be in a proper time domain format for input to ML models 714. As another example, data set preparation module 712 may perform discrete cosine transforms on the vibration data sets such that the vibration data sets can be analyzed by ML models 714. In general, data set preparation module 712 can perform processing on vibration data sets received from data set collector 710 to ensure input to ML models 714 is in a proper format. In some embodiments, if ML models 714 use raw vibration signals as input, data set preparation module 712 may or may not be a component of memory 706. In some embodiments, ML models 714 directly utilize timewave data as inputs to analyze vibration data sets which may or may not require data preparation by data set preparation module 712.

ML models 714 can include one or more ML models that can determine probabilities that a vibration data set includes at least one abnormality based on FFT spectra. For example, an ML model of ML model 714 may predict that a first vibration data set has a 30% probability of including an abnormality whereas a second vibration data set has a 70% probability of including an abnormality. In some embodiments, ML models 714 output a different indicator of abnormalities in vibration data sets. For example, an ML model of ML models 714 may output a binary decision (e.g., yes or no) indicating whether or not the ML model predicts that a vibration data set includes an abnormality.

ML models 714 can provide additional information for analysts to consider if evaluating machine health of building equipment 720. Insight provided by ML models 714 may include predicted health scores for specific machine components, a determination of important machine speeds, highlighting of regions of vibration spectra that need attention, etc. In this way, analyst efficiency in analyzing vibration data sets can increase by providing additional information beyond raw vibration data.

ML models 714 can also assess a condition of an entire device and indicate whether the device is functioning normally, or if the device is potentially abnormal and should be evaluated by a human analyst. In this way, ML models 714 can eliminate some vibration data sets from needing to be analyzed by an analyst, thereby increasing efficiency of the analyst. In some embodiments, if enough data is available, ML models 714 can be trained to automatically and accurately diagnose faults in building equipment 720. However, if accuracy of all decisions is of high priority (e.g., to a user), some and/or all vibration data sets identified as being potentially abnormal may be evaluated by human analysts to ensure that diagnoses of equipment problems are accurate.

ML models 714 may include a variety of ML models generated for various building devices of building equipment 720. For example, ML models 714 may include ML models for identifying/predicting abnormalities in vibration data sets for chillers, pumps, fans, etc. Generating models for different building equipment may be important if multiple devices are analyzed as certain devices may be associated with more vibrations as opposed to others. In other words, a normal amount of vibration for one building device may not be the same for a separate building device (e.g., a normal amount of vibration for a chiller may not be the same as for a boiler). As such, each building device and/or building device type can have a separate ML model for analyzing vibration data. In any case, an ML model of ML models 714 can evaluate vibration data collected from a building device and determine whether any of the vibration spectra (i.e., the FFT spectra) for the building device are abnormal. Results from vibration spectra can be aggregated to determine whether the entire dataset may be abnormal. In this way, output of ML models 714 can be used to filter out vibration datasets that are “normal” and do not need to be evaluated by a human analyst. In some embodiments, ML models 714 further detect specific types of faults or machine malfunctions, as opposed to generic abnormalities.

In some embodiments, ML models 714 include convolutional neural networks (CNNs). CNNs can be useful particularly problems where local relationships within input data are important (e.g., image classification tasks). In other words, CNNs can be useful in cases where repeating patterns exist throughout a sample input. While analysis of vibration spectra may be complex, signatures of abnormal equipment function can often be detected visually in the frequency domain. As such, CNN models can be utilized to identify abnormal vibration signals can reliably automate a portion of vibration analysis. As described above, reduction in a number of data sets manually analyzed by analysts can allow the analysts to focus on suspected abnormal equipment and thus accommodate a larger volume of data. In terms of ML models 714, the CNNs may be used to classify one-dimensional inputs.

CNNs can include convolutional layers, activation layers, pooling layers, and fully connected layers. A convolutional layer can include a number of filters that can learn different features from an input. With specific regard to ML models 714, the filters may learn to recognize, for example, FFT peaks and peak patterns, regardless of whether they appear in input. Convolutional layers may result in parameter sharing as peaks and spectral patterns may repeat throughout an FFT spectrum sample. Activation layers of CNNs can apply an activation function to their inputs. With regards to CNNs of ML models 714, the CNNs can utilize rectified linear unit (ReLU) activation layers which can apply the following activation function:

f(x)=max(0,x)

where x is some input value. Pooling layers of CNNs can downsample their input to decrease a complexity of the CNN model. Specifically, downsampling can reduce a number of parameters of the CNN model. For example, pooling layers may take maximum values across small regions of the input to reduce a number of variables across each small region to one (i.e., the maximum value). Fully connected layers of CNNs can operate as ordinary neural networks and can be used at the end of a CNN to output a final class score. In this way, the fully connected layers can output abnormality probabilities based on the FFT spectra received from data set preparation module 712.

Each spectrum one-dimensional CNN models of ML models 714 can evaluate one type of FFT of the FFT spectra provided by data set preparation module 712. Machine specs and spectrum-specific info (e.g., location and orientation of a sensor that made the vibration measurement) can be incorporated in the final layers of each model. Spectrum CNN models can be trained on labeled historical data that is available (e.g., stored in database 726) so that the spectrum CNN models output a probability that a given spectrum is abnormal (i.e., is indicative of a machine fault). In some embodiments, the spectrum CNN models further predict a specific type of machine fault that is present based on the FFT spectra. For example, the spectrum CNN models may learn to associate certain FFT spectra patterns with specific component failures. An example of CNN models that can be used to predict probabilities based on FFT spectra is described in detail in U.S. Pat. No. 11,422,547 granted Aug. 23, 2022, the entire disclosure of which is incorporated by reference herein

To achieve good performance of abnormality predictions, CNN models of ML models 714 may require a large amount of training data. However, obtaining a large number of labeled vibration datasets may not be feasible for all equipment types, and so, data availability may be a limiting factor for extending the anomaly detection models. To mitigate data availability problems, the CNN models may be trained using transfer learning. With transfer learning, an ML model can be trained on one set of data and then applied to a separate set of data for which there may be significantly less data. The ML model can be fine-tuned on the new set of data, but the performance is helped significantly by what the ML model learns from the first set of data. Transfer learning may work especially well if fundamental features the CNN learns (e.g., FFT peaks) are the same for the two data sets.

As an example of transfer learning that can be used in training the CNNs, a spectrum CNN model for a first chiller type may be trained based at least partially on vibration data sets for a second chiller type. In this case, the spectrum CNN model can be trained based on the vibration data sets and/or CNN models for the second chiller type and fine-tuned based on vibration data sets for the first chiller type. Specifically, the spectrum CNN model can be initially trained based on the vibration data sets for the second chiller type. Some of the learned weights of the spectrum CNN model can be fixed prior to fine-tuning based on vibration data sets for the first chiller type. In this case, a number of layers of the spectrum CNN model that are fixed can be configurable by testing what layers being fixed results in the best performance. In this way, the spectrum CNN model can be trained to predict abnormalities in vibration data sets for the first chiller type using data for the second chiller type.

It should be appreciated that CNNs are given purely for sake of example. The ML models of ML models 714 can be based on any appropriate type of machine learning model that can be used to classify vibration data sets. For example, ML models 714 may include long short-term memory (LSTM) models, other recurrent neural networks, etc. Dependent on a type of ML model used, data set preparation module 712 may or may not be included in data set abnormality controller 700. Further, data set preparation module 712 may perform other operations as opposed to and/or in addition to FFTs. In this sense, data set preparation module 712 can be configured and customized to prepare data in a format that can be used as input by ML models 714.

In some embodiments, ML models 714 are optimized for recall (a percentage of faulty machines ML models 714 are able to detect) or precision (a percentage of building devices that ML models 714 classify as faulty that are actually faulty). As ML models 714 catch more fault (i.e., recall increases), a higher number of “false alarms” (i.e., building devices identified as faulty that are operating normally) may increase as well. In other words, as recall increases, precision may decrease and vice-versa.

Model performance of ML models 714 can be tuned by adjusting a probability threshold used to assign normal and abnormal labels to vibration data sets. A higher threshold may result in lower recall and fewer false positives, whereas a lower threshold may achieve high recall (e.g., near 100% recall) but may have more false positives. If a goal of a user and/or data set abnormality controller 700 is to catch as many equipment faults as possible (i.e., near-100% recall) and ensure no critical faults are missed by ML models 714, the probability threshold may be lowered to a value that helps decrease a probability of missed equipment faults. However, the probability threshold may be required to be over a predetermined minimum value (e.g., 10%, 20%, 50%, etc.) such that a number of vibration data sets manually analyzed by analysts is reduced. If an extremely low probability threshold is used (e.g., 0%, 1%, etc.), a large number of vibration data sets that can be safely classified as normal may be unnecessarily qualified as abnormal, thereby increase a workload on analysts. In other words, the probability threshold should be set (e.g., by a user, by data set abnormality controller 700, etc.) such that a number of “acceptable” data sets (i.e., data sets that do not indicate a fault) classified as normal by ML models 714 is maximized while a number of non-acceptable data sets (i.e., data sets that indicate a fault) classified as normal by ML models 714 is minimized.

In some embodiments, the probability threshold is selected respective to types of equipment faults that can occur. For example, equipment faults may be classified as either “alert” faults (i.e., minor faults) or “alarm”/“danger” faults (i.e., critical faults). In this case, alert faults may indicate some fault that may, for example, raise operational costs, but would not be catastrophic to a system if left unaccounted for. Alarm/danger faults, however, may indicate equipment faults that, if left unaccounted for, may result in very large increases in operational costs, system failure, and/or other significant outcomes for a system. Based on the equipment fault classifiers, the probability threshold for ML models 714 can be set respective of the classifiers. For example, a conservative probability threshold may be set such that effectively no alert faults or alarm/danger faults are misclassified as normal. As another example, a less conservative probability threshold for ML models 714 may be set such that a few alert faults may be misclassified but that no alarm/danger fault are misclassified. In some embodiments, the probability threshold is automatically adjusted by data set abnormality controller 700 based on feedback about misclassifications from a user and based on a tolerance for misclassified faults and false positives set by the user (or some other entity).

As a result of passing an FFT spectra for a vibration data set through ML models 714, a set of abnormality probabilities for the FFT spectra can be calculated and provided to an abnormality identifier 716. For a given FFT spectrum, a specific ML model associated with a frequency range (or other aspect) of the FFT spectrum can analyze the FFT spectrum to determine a probability that the FFT spectrum is abnormal. This process can be repeated for each FFT spectrum of the vibration data set such that abnormality identifier 716 can receive an abnormality probability for each FFT spectrum.

Still referring to FIG. 7, data set abnormality controller 700 is shown to include an operator comment classifier 713. Operator comment classifier 713 can be configured to classify the operator comments received from operator devices 721 based on whether the operator comments indicate an observed abnormality in building equipment 720. In some embodiments, operator comment classifier 713 classifies the operator comments into predetermined categories such as “abnormal,” “normal,” or “unknown” based on the content of the operator comments. Operator comment classifier 713 can apply labels to the operator comments indicating the categories into which the operator comments are classified. The categories or labels used by operator comment classifier 713 can be provided by a user, automatically generated by operator comment classifier 713, or obtained from database 726 in various embodiments. As one example, the operator or user may provide input labels of “vibration,” “no vibration,” and “unknown” and operator comment classifier 713 may classify each of the operator comments into one of these categories. Some categories or labels may indicate abnormal operation of building equipment 720 (e.g., “abnormal,” “vibration,” etc.) whereas other categories or labels may indicate normal operation of building equipment 720 (e.g., “normal,” “no vibration,” etc.).

In some embodiments, operator comment classifier 713 includes a machine learning model, an artificial intelligence model, and/or a neural network model and uses such model(s) to classify the operator comments. Examples of models which can be used by operator comment classifier 713 include, without limitation, one or more natural language processing (NLP) models, large language models (LLMs), attention-based neural networks, transformer-based neural networks, generative pretrained transformer (GPT) models, bidirectional encoder representations from transformers (BERT) models, encoder/decoder models, sequence to sequence models, autoencoder models, generative adversarial networks (GANs), convolutional neural networks (CNNs), recurrent neural networks (RNNs), diffusion models (e.g., denoising diffusion probabilistic models (DDPMs)), a retrieval augmented generation (RAG) model, or various combinations thereof. In some embodiments, operator comment classifier 713 may include any or all of the various types of models described in U.S. patent application Ser. No. 18/633,068 filed Apr. 11, 2024, the entire disclosure of which is incorporated by reference herein. In various embodiments, operator comment classifier 713 can be implemented as a few-shot classifier (transformer), a fine-tuned LLM, a RAG model, or any combination thereof, as described in greater detail with reference to FIGS. 9-11.

In some embodiments, operator comment classifier 713 includes a generative artificial intelligence (GAI) model such as a GPT model and can use the GPT model to classify the operator comments. The GPT model can receive an input sequence, and can parse the input sequence to determine a sequence of tokens (e.g., words or other semantic units of the input sequence, such as by using Byte Pair Encoding tokenization). The GPT model can include or be coupled with a vocabulary of tokens, which can be represented as a one-hot encoding vector, where each token of the vocabulary has a corresponding index in the encoding vector; as such, the GPT model can convert the input sequence into a modified input sequence, such as by applying an embedding matrix to the token tokens of the input sequence (e.g., using a neural network embedding function), and/or applying positional encoding (e.g., sin-cosine positional encoding) to the tokens of the input sequence. The GPT model can process the modified input sequence to determine a next token in the sequence (e.g., to append to the end of the sequence), such as by determining probability scores indicating the likelihood of one or more candidate tokens being the next token, and selecting the next token according to the probability scores (e.g., selecting the candidate token having the highest probability scores as the next token). For example, the GPT model can apply various attention and/or transformer based operations or networks to the modified input sequence to identify relationships between tokens for detecting the next token to form the output sequence.

Operator comment classifier 713 can be configured to receive and process operator comments in a variety of different formats to extract useful information from the operator comments regardless of the particular format of the operator comments. For example, operator comment classifier 713 can receive the operator comments in unstructured/freeform formats, which can allow service technicians or other operators to input information without conforming to a predetermined format or template. Operator comment classifier 713 can receive the operator comments in a plurality of formats (e.g., text, speech, audio, image, video, etc.), including multi-modal formats. For example, the operator comments may be received from operator devices 721 in forms such as text (e.g., laptop/desktop or mobile application text entry), audio, and/or video (e.g., dictating findings while capturing video).

In some embodiments, operator comment classifier 713 is trained to classify operator comments using a training data set of operator comments and corresponding analyst assessments. The analyst assessments can be provided by one or more analyst devices 722 and may indicate whether a vibration data set is normal or abnormal in the opinion of the analyst. The analyst assessments can be provided as feedback to data set abnormality controller 700 and may be associated with corresponding sets of vibration data and/or operator comments in database 726. Operator comment classifier 713 can be trained to learn a relationship between the operator comments and the corresponding analyst assessments. For example, if a certain word or phrase in the operator comments (e.g., “excessive noise”) is correlated with analyst assessments that indicate the corresponding vibration data sets are abnormal, operator comment classifier 713 may learn to associate such operator comments with the data set being abnormal. Conversely, if a certain word or phrase in the operator comments (e.g., “everything appears normal”) is correlated with analyst assessments that indicate the corresponding vibration data sets are normal, operator comment classifier 713 may learn to associate such operator comments with the data set being normal. Operator comment classifier 713 can apply a label or classification to the operator comments and provide the comment classifications (e.g., the labels, the classified operator comments, etc.) to abnormality identifier 716.

Abnormality identifier 716 can determine whether each vibration data set is normal or abnormal based on the abnormality probabilities generated by ML models 714 and/or the associated operator comments (if any) generated by operator comment classifier 713 for the vibration data set. Abnormality identifier 716 can determine whether the vibration data set is normal or abnormal through a variety of methods. In some embodiments, abnormality identifier 716 determines that the vibration data set is abnormal in response to the operator comment classifications generated by operator comment classifier 713 indicating an abnormality. In some embodiments, abnormality identifier 716 determines that the vibration data set is abnormal in response to the abnormality probabilities generated by ML models 714 exceeding one or more thresholds. In various embodiments, abnormality identifier 716 can determine whether a vibration data set is normal or abnormal based on only the abnormality probabilities generated by ML models 714, only the operator comment classifications generated by operator comment classifier 713, or both the abnormality probabilities generated by ML models 714 and the operator comment classifications generated by operator comment classifier 713 in combination with each other.

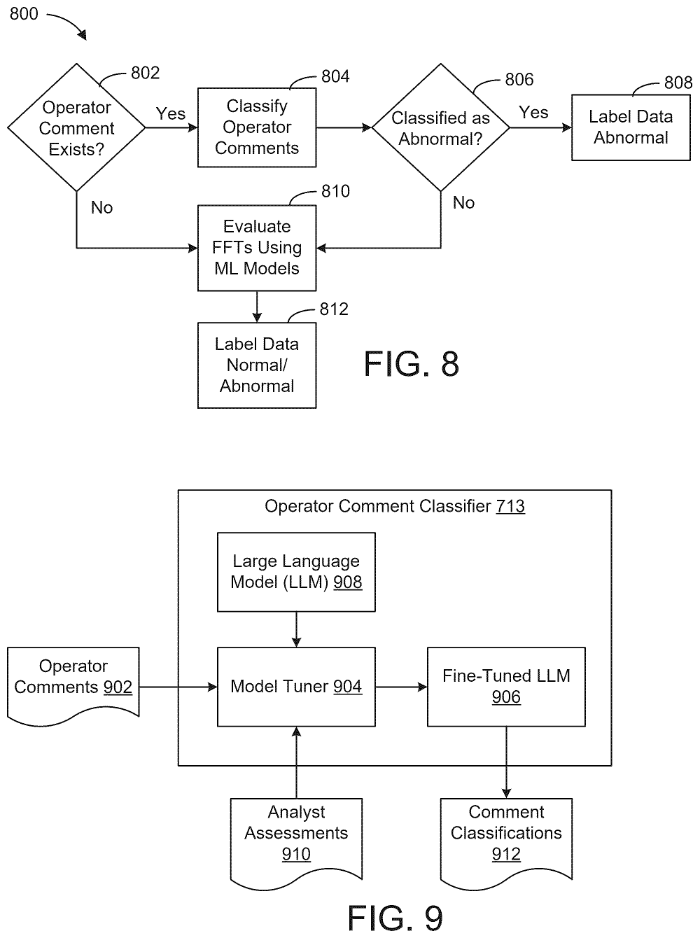

In some embodiments, abnormality identifier 716 includes one or more artificial intelligence models (e.g., machine learning models, neural network models, etc.) configured to receive the abnormality probabilities generated by ML models 714 and/or the comment classifications generated by operator comment classifier 713 as inputs and generate a label for the vibration data set based on these inputs. The label may indicate whether the vibration data set is normal, abnormal, or any other category for which a label can be defined (e.g., within bounds, outside normal operating range, vibration, no vibration, etc.). Advantageously, using both the abnormality probabilities and the comment classifications allows abnormality identifier 716 to more accurately predict the states of building equipment 720 (relative to past approaches that use only the abnormality probabilities) and label the vibration data sets with corresponding labels. For example, for any vibration data sets for which the abnormality probabilities are inconclusive (e.g., around 50%), the additional information provided by the operator comments and classifications generated by operator comment classifier 713 may allow abnormality identifier 716 to accurately classify the state of building equipment 720 and apply a corresponding label to the vibration data set. One example of a process which can be performed by abnormality identifier 716 to determine whether a vibration data set is normal or abnormal is described in greater detail with reference to FIG. 8.

In some embodiments, abnormality identifier 716 determines whether the vibration data set is normal or abnormal by identifying a maximum abnormality probability included in the set of abnormality probabilities. For example, if the FFT spectra of the vibration data set included three FFT spectrums which have respective abnormality probabilities of 10%, 30%, and 60% as determined by ML models 714, abnormality identifier 716 may identify 60% as the maximum abnormality probability. Abnormality identifier 716 can determine whether the maximum abnormality probability is greater than or equal to a threshold probability for abnormality and, if the maximum abnormality is greater than or equal to the threshold probability, can identify the vibration data set as abnormal. Taking the maximum abnormality probability of a received set of abnormality probabilities can be a computationally simple process and can ensure that the vibration data set is treated cautiously to reduce a change of mislabeling the vibration data set as normal if the vibration data set is abnormal.

In some embodiments, abnormality identifier 716 determines a label for the vibration data set based on a model. In this case, abnormality identifier 716 can provide each abnormality probability of the received set of abnormality probabilities to the model to determine whether to classify the vibration data set as normal or abnormal. The model used by abnormality identifier 716 may include a supervised learning algorithm such as, for example, a logistic regression model, a support vector machine (SVM) model, decision trees, etc. Specifically, the model used by abnormality identifier 716 can determine a final probability based on each abnormality probability and can compare the final probability to the threshold probability. Using the model can be helpful in more accurately classifying vibration data sets as normal or abnormal. In particular, using the model in abnormality identifier 716 can reduce an impact of high outlier probabilities in the set of abnormality probabilities. For example, if a first FFT spectrum is associated with an abnormality probability of 80% whereas all other FFT spectra associated with a vibration data set have an abnormality probability less than 5%, the first FFT spectrum may have been misidentified by an ML model of ML models 714. In this example, using the maximum probability may unnecessarily qualify the vibration data set as abnormal whereas the model may determine a final probability that qualifies the vibration data set as normal.

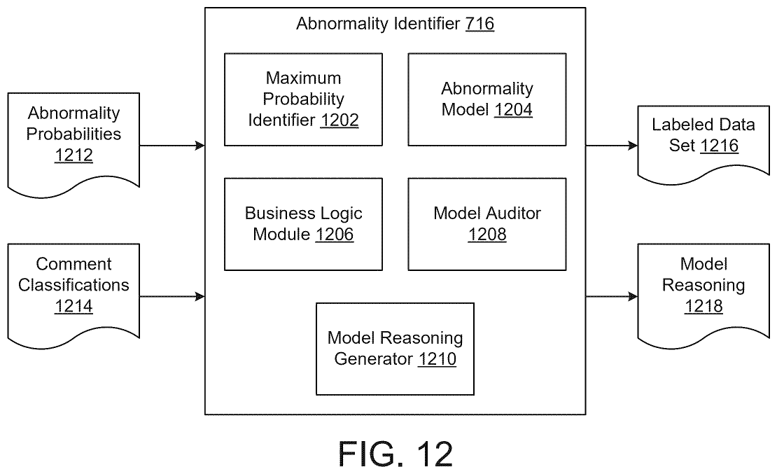

The model utilized by abnormality identifier 716 can be trained to learn which features are particularly important for arriving at a correct label of normal or abnormal for a vibration data set. In some embodiments, the model accounts for differences in how the output probabilities of different models of ML models 714 are calibrated. In some embodiments, the model accounts for additional information such as machine specification values (e.g., gear ratio, line frequency, etc.) to better classify vibration data sets. In some embodiments, abnormality identifier 716 includes business logic and/or auditing capabilities for further analyzing vibration data sets. In effect, abnormality identifier 716 may include any appropriate functionality for labeling vibration data sets as normal or abnormal. Abnormality identifier 716 is described in greater detail below with reference to FIG. 12.

Based on a received set of abnormality probabilities, abnormality identifier 716 can label an associated vibration data set as normal or abnormal. If abnormality identifier 716 labels the vibration data set as normal, the vibration data set can be provided to a report generator 718 as described in greater detail below. However, if abnormality identifier 716 labels the vibration data set as abnormal, abnormality identifier 716 can provide the abnormal vibration data set to an analyst device 722.

Analyst device 722 can be any device associated with an analyst that can allow the analyst to view a vibration data set and provide feedback about the vibration data set. As such, analyst device 722 may include one or more personal computing devices associated with the analyst. Analyst device 722 may include any wearable or non-wearable device. Wearable devices can refer to any type of device that an individual wears including, but not limited to, a watch (e.g., a smart watch), glasses (e.g., smart glasses), bracelet (e.g., a smart bracelet), etc. Analyst device 722 may also include any type of mobile device including, but not limited to, a phone (e.g., smart phone), a tablet, a personal digital assistant, etc. In some embodiments, analyst device 722 includes other computing devices such as a desktop computer, a laptop computer, etc. Analyst device 722 can be configured to display a graphical user interface including vibration data sets to the analyst and receive user input to the graphical user interface. In some embodiments, analyst device 722 includes a touchscreen. Analyst device 722 may be communicable with the data set abnormality controller 700 via a network, for example a Wi-Fi network, a Bluetooth network, a cellular network, etc.

Via analyst device 722, the analyst can provide analyst assessments as feedback. Specifically, the analyst may indicate whether a vibration data set classified as abnormal by abnormality identifier 716 is actually abnormal in the opinion of the analyst. If the analyst indicates the vibration data set is normal, the vibration data set can be provided to report generator 718 such that report generator 718 can generate a “normal” report. However, if the analyst indicates the vibration data set is correctly classified as abnormal by abnormality identifier 716, various corrective actions may be taken to address the abnormality. In some embodiments, one corrective action is to provide the abnormal data set to report generator 718 to generate a report detailing the abnormality.

In some embodiments, corrective actions such as maintenance, replacement, and/or other repairs of building equipment 720 may be initiated. For example, a specific building device of building equipment 720 may be scheduled to be replaced based on the analyst indicating an abnormality exists. Corrective actions may be initiated by the analyst via analyst device 722, automatically by abnormality identifier 716 and/or another component of data set abnormality controller 700, and/or by any other entity authorized to initiate corrective actions. In some embodiments, abnormality identifier 716 initiates a corrective action upon identifying the vibration data set as abnormal. In some embodiments, however, abnormality identifier 716 may be restricted in what corrective actions can be taken prior to confirming abnormality with the analyst. In this case, providing the vibration data set to the analyst may be considered a corrective action. Other valid corrective actions the abnormality identifier 716 may initiate may include providing the vibration data set to report generator 718 to generate an initial abnormal report for the vibration data set, alerting a user of user device 724 that abnormality may be present, etc. Abnormality identifier 716 may be restricted, for example, from initiating a corrective action to replace building equipment before confirming abnormality with the analyst.

In some embodiments, abnormality identifier 716 provides abnormal data sets to multiple analyst devices 722. In this case, multiple analysts can review the abnormal data sets and provide feedback. Providing abnormal data sets to multiple analysts can reduce a chance that vibration data sets are mislabeled by analysts. For example, one analyst may accidentally misinterpret an abnormal data set provided by abnormality identifier 716 as normal, thereby missing an equipment fault. However, if the abnormal data set is provided to multiple analysts, the other analysts may detect the equipment fault in the abnormal data set. In some embodiments, if multiple analysts provide feedback on a supposedly abnormal data set, a predetermined percentage of analysts (e.g., 10% of analysts, 30% of analysts, 60% of analysts, etc.) may be required to indicate the supposedly abnormal data is truly abnormal for a corrective action to be initiated. In some embodiments, only one analyst (or another predetermined number of analysts) is required to indicate abnormality in a data set for a corrective action to be initiated.

Labeled vibration data sets can be provided to report generator 718. Based on a vibration data set, report generator 718 can automatically generate a report that can be provided to a user (e.g., a customer) of user device 724. In some embodiments, user device 724 is similar to and/or the same as analyst device 722. As such, user device 724 may be or include, for example, wearable devices, desktop computers, mobile devices, etc.

If a received vibration data set is labeled as normal, report generator 718 may generate a normal report indicating that building equipment is operating normally. If a received vibration data is labeled as abnormal (e.g., as indicated by an analyst), report generator 718 may generate an abnormal report detailing the abnormality. Abnormal reports may include various information that may be helpful to the user. For example, the abnormal report may include what building device of building equipment 720 is experiencing a fault, possible corrective actions that can be taken to address the fault, etc. In effect, the abnormal report can include any information that can help the user make an informed decision on how to proceed with regards to the fault.

Referring now to FIG. 8, a flowchart of a process 800 which can be performed by data set abnormality controller 700 to label data sets as normal or abnormal is shown, according to an exemplary embodiment. In some embodiments, various steps of process 800 may be performed by operator comment classifier 713, ML models 714, and/or abnormality identifier 716. Process 800 can be performed for each vibration data set received from building equipment 720. In some embodiments, process 800 is initiated automatically (e.g., performed in response to detecting predetermined triggers, periodically at predetermined intervals, etc.) or can be executed on demand (e.g., in response to a request from a user or automated system).

Process 800 is shown to include determining whether operator comments exist (step 802). Step 802 may include using the associations stored by data set collector 710 to determine whether any operator comments have been received for a given vibration data set. Step 802 may include determining whether any operator comments exist for the particular device of building equipment 720 associated with the vibration data set. If any operator comments exist for that device of building equipment 720, step 802 may include comparing the times at which the operator comments were entered (e.g., based on timestamps included in the operator comments or added to the operator comments by data set collector 710) to the times at which the vibration data set was generated (e.g., based on timestamps included in the vibration data set) to determine whether the operator comments are for the same or similar time period as the vibration data set.

If step 802 determines that operator comments exist, process 800 may proceed to classifying the operator comments (step 804). Step 804 may be performed by operator comment classifier 713 and may include any of the actions performed by operator comment classifier 713 as described throughout the present disclosure. Step 804 may include applying a classification (e.g., a label or category) to each of the operator comments. The classification may indicate whether the operator comments are normal, abnormal, or any other label or category. If the operator comments are classified as abnormal in step 804 (i.e., the result of step 806 is “yes”), process 800 may proceed to labeling the data set as abnormal in step 808. However, if the operator comments are classified as normal or otherwise not classified as abnormal in step 804 (i.e., the result of step 806 is “no”), process 800 may proceed to step 810.

If step 802 determines that operator comments do not exist or step 806 determines that the operator comments are not classified as abnormal, process 800 may proceed to evaluating the FFTs generated by data set preparation module 712 using ML models 714 (step 810). Step 810 may be performed by ML models 714 and may include any of the actions performed by ML models 714 as described throughout the present disclosure. Step 810 may include generating a classification (e.g., a label or category) indicating whether the data set is normal, abnormal, or any other classification which can be determined using ML models 714. Process 800 may then proceed to labeling the data set as normal, abnormal, or any other category (step 812) using the labels generated by ML models 714.

Referring now to FIGS. 9-11, various embodiments of operator comment classifier 713 are shown illustrating various techniques which can be used by operator comment classifier 713 to classify the operator comments received from operator devices 721. FIG. 9 illustrates an embodiment in which operator comment classifier 713 includes a large language model (LLM) 908. LLM 908 may include any type of LLM such as a generative pretrained transformer (GPT) model (e.g., ChatGPT), a bidirectional encoder representation from transformer (BERT) model, a robustly optimized BERT training approach (ROBERTa) model, or any other type of LLM (e.g., a retrainable GPT model, Davinci, Babbage, Curie, Ada, etc.). In some embodiments, LLM 908 is a trainable LLM which is not customized to the particular data sets used by operator comment classifier 713, but can be trained to generate a fine-tuned LLM 906.

As shown in FIG. 9, operator comment classifier 713 may include a model tuner 904. Model tuner 904 can be configured to use a training data set of operator comments 902 and analyst assessments 910 to tune (e.g., fine-tune) or train LLM 908 to generate fine-tuned LLM 906. Analyst assessments 910 can be provided by one or more analyst devices 722 and may indicate whether a vibration data set is normal or abnormal in the opinion of the analyst. Analyst assessments 910 can be provided as feedback to model tuner 904 and may be associated with corresponding sets of vibration data and/or operator comments 902. Model tuner 904 can be trained to learn a relationship between operator comments 902 and the corresponding analyst assessments 910. For example, if a certain word or phrase in operator comments 902 (e.g., “excessive noise”) is correlated with analyst assessments 910 that indicate the corresponding vibration data sets are abnormal, model tuner 904 can train LLM 908 to associate such operator comments 902 with the data set being abnormal. Conversely, if a certain word or phrase in operator comments 902 (e.g., “everything appears normal”) is correlated with analyst assessments 910 that indicate the corresponding vibration data sets are normal, model tuner 904 can train LLM 908 to associate such operator comments 902 with the data set being normal.

The model training or tuning process performed by model tuner 904 may transform the initial (e.g., generic) LLM 908 into a fine-tuned LLM 906 specifically configured or tuned to classify operator comments 902. The data used by model tuner 904 may include a training data set of operator comments 902 and corresponding analyst assessments 910. Once trained, fine-tuned LLM 906 can be used to generate or predict comment classifications 912 for new operator comments 902 before corresponding analyst assessments 910 are generated or available. Comment classifications 912 can be used (e.g., by operator comment classifier 713) to apply a label or classification to operator comments 902. Comment classifications 912 can be provided as an input to abnormality identifier 716 and/or process 800 and used as previously described.

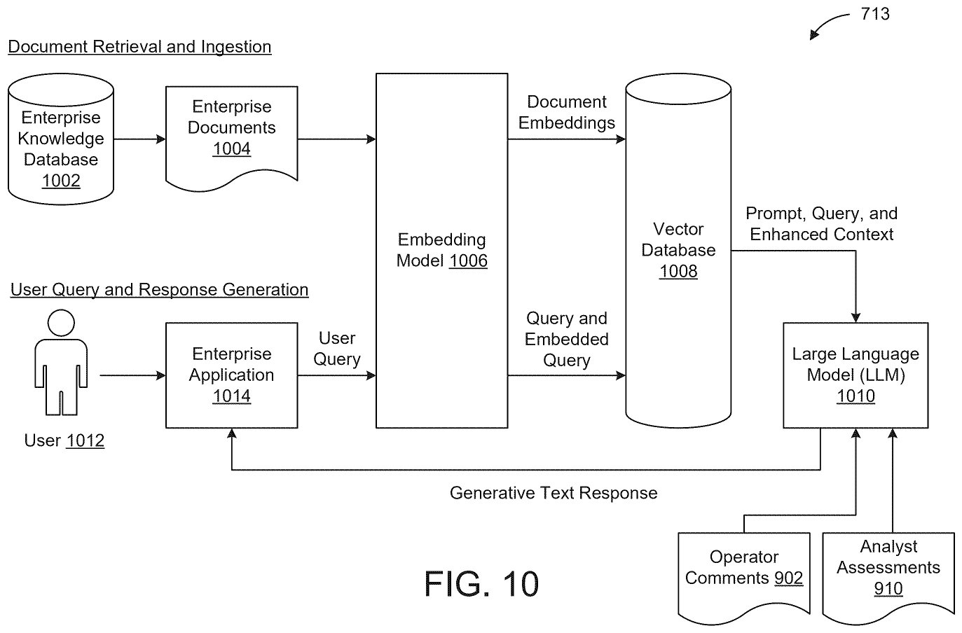

Referring now to FIG. 10, operator comment classifier 713 is shown as a retrieval augmented generation (RAG) model, according to an exemplary embodiment. RAG is a technique for enhancing the accuracy and reliability of generative AI models with information obtained from external sources. In the embodiment shown in FIG. 10, such external information is shown as enterprise documents 1004. Operator comment classifier 713 may retrieve enterprise documents 1004 from an enterprise knowledge database 1002 (e.g., one or more databases or repositories of enterprise documents 1004) and use the information provided by enterprise documents 1004 to enhance the accuracy and reliability of a response to a user query. In some embodiments, the various components of operator comment classifier 713 are connected using a LLM framework (e.g., LangChain) or other frameworks to facilitate communications between interoperable LLM components.

Enterprise documents 1004 may include any type of document or information describing building equipment 720 (e.g., equipment models, equipment types, equipment characteristics, etc.), the layout of building equipment 720 (e.g., connections between building equipment 720), specifications or performance of building equipment 720, manuals for building equipment 720 (e.g., operating manuals, service manuals, troubleshooting guides, etc.), or any other type of documents which provide information about building equipment 720 and/or the operation thereof. In various embodiments, enterprise documents 1004 may include engineering drawings, process flow diagrams, refrigeration cycle parameters (e.g., temperatures, pressures), or various other information relating to structures and functions of items of building equipment 720. Enterprise documents 1004 may include operating manuals, technical data sheets, configuration settings, operating setpoints, diagnostic guides, troubleshooting guides, user reports, technician reports, service manuals, instruction manuals, or any other information associated with building equipment 720. Enterprise documents 1004 may include operational data generated during operation of building equipment 720, warranty data indicating a warranty and/or warranty status associated with building equipment 720, parts data indicating parts usage associated with building equipment 720, a history of service requests or service actions performed for building equipment 720, outcome data indicating outcomes of the service requests, or any other data associated with building equipment 720 or the service requests. In some embodiments, enterprise documents 1004 include any of the various types of additional data and/or data sources described in U.S. patent application Ser. No. 18/633,068 filed Apr. 11, 2024, the entire disclosure of which is incorporated by reference herein.

Operator comment classifier 713 may extract information from enterprise documents 1004 and provide the extracted information or enterprise documents 1004 as inputs to an embedding model 1006 to create document embeddings. The document embeddings may be provided to a vector database 1008. Asynchronously or in parallel with the document retrieval and ingestion steps (i.e., the top path shown in FIG. 10), operator comment classifier 713 may receive a user query from a user 1012 and generate a response to the user query. In some embodiments, the user query and response are provided via an enterprise application 1014 or any other type of interface with user 1012. The user query can be provided as an input to embedding model 1006 to create additional embeddings, shown as an embedded query in FIG. 10. The query and embedded query can then be provided to vector database 1008.

Vector database 1008 may generate a prompt for large language model (LLM) 1010 along with the original user query and enhanced context using information extracted from enterprise documents 1004. In various embodiments, LLM 1010 may be the same as or similar to LLM 908 and/or fine-tuned LLM 906 as described with reference to FIG. 9, or may include any other type of generative AI model, machine learning model, neural network model, or other type of AI model described throughout the present disclosure (e.g., a GPT model). In some embodiments, LLM 1010 is trained or fine-tuned using operator comments 902 and/or analyst assessments 910 as described with reference to FIG. 9. LLM 1010 can be configured to generate a text response to the user query and present the text response to user 1012 via enterprise application 1014.

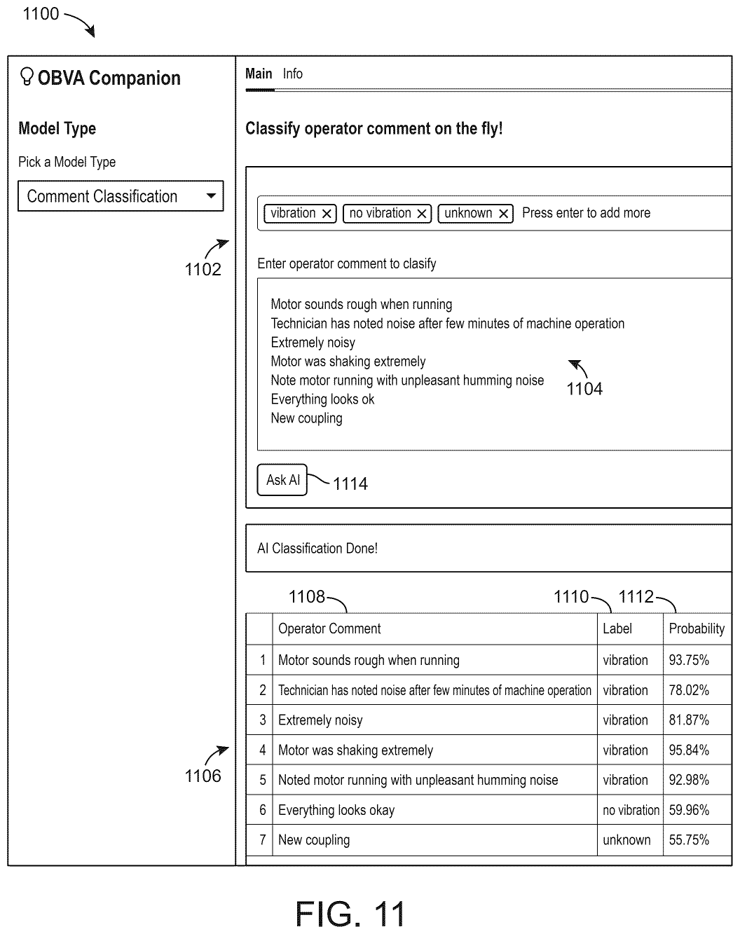

Referring now to FIG. 11, an interface 1100 is shown for an embodiment in which operator comment classifier 713 is implemented as a few-shot classifier or transformer. Few-shot classification may include a training phase in which operator comment classifier 713 is trained using a relatively large dataset and an adaptation phase in which operator comment classifier 713 is adapted to previously unseen tasks with limited labeled samples. In the context of data set abnormality controller 700, few-shot classification may include training operator comment classifier 713 using a training data set of operator comments 902 and corresponding analyst assessments 910 and then using operator comment classifier 713 to classify new operator comments 1104 received from operator devices 721.

Interface 1100 is shown to include several input labels 1102 including “vibration,” “no vibration,” and “unknown” which can be specified by a user or automatically generated by operator comment classifier 713. In some embodiments, interface 1100 may allow the user to enter any number of input labels 1102 (e.g., via one or more fields of interface 1100) as the categories into which the operator comments 1104 will be classified. Interface 1100 may allow the user to specify input labels 1102 by entering the text of input labels 1102, selecting input labels 1102 from a pre-populated list of potential input labels 1102, or may automatically generate or suggest input labels 1102 based on the type of data being classified (e.g., vibration, temperature, pressure, etc.) and/or content of operator comments 1104.

Interface 1100 may also allow the user to enter operator comments 1104. The examples of operator comments 1104 shown in FIG. 11 are textual comments including “motor sounds rough when running,” “technician has noted noise after a few minutes of machine operation,” “extremely noisy,” “motor was shaking extremely,” “noted motor running with unpleasant humming noise,” “everything looks okay,” and “new coupling,” but are not limited to these examples. Operator comments 1104 can include any type of information provided by operators in any of a variety of modalities or formats (e.g., text, video, photos, audio, etc.) as previously described. In general, operator comments 1104 may include the operator's personal observations or notes on the operation of building equipment 720 at the time the vibration data set is collected.

After specifying input labels 1102 and providing operator comments 1104, the user can interact with interface 1100 (e.g., by selecting the “ask AI” button 1114) to cause operator comment classifier 713 to classify operator comments 1104 into the categories defined by input labels 1102. The output of operator comment classifier 713 is shown in portion 1106 of interface 1100 and may include a listing of the operator comments 1108, the label or labels 1110 applied to each operator comment 1108, and probabilities 1112 that the applied labels 1110 accurately describes the corresponding operator comments 1108. Operator comment classifier 713 can use a few-shot classification technique or any other technique described herein to apply labels 1110 to operator comments 1108.

Referring now to FIG. 12, a block diagram of abnormality identifier 716 in greater detail is shown, according to some embodiments. In operation, abnormality identifier 716 may receive as inputs the abnormality probabilities 1212 generated by ML models 714 and/or the comment classifications 1214 generated by operator comment classifier 713. Abnormality identifier 716 may process these inputs to generate labels for the vibration data set and output a labeled data set 1216 (e.g., the generated labels and/or the vibration data set). In some embodiments, abnormality identifier 716 may also output model reasoning 1218 indicating the specific reason or reasons why a certain label was applied or indicating specific portions of the vibration data set that led to the label being applied. Model reasoning 1218 may provide insight into the operation of abnormality identifier 716 to allow a user to understand why certain labels were applied and readily identify the relevant data for human analysis.

Abnormality identifier 716 is shown to include a maximum probability identifier 1202 and an abnormality model 1204. Maximum probability identifier 1202 and abnormality model 1204 are examples of components that abnormality identifier 716 may include to label vibration data sets based on a set of abnormality probabilities. Specifically, maximum probability identifier 1202 may label vibration data sets based on a maximum probability in associated sets of abnormality probabilities whereas abnormality model 804 may described a supervised learning algorithm (e.g., a logistic regression, an SVM, decision trees, etc.) that can label vibration data sets based on sets of abnormality probabilities and/or other information. Maximum probability identification and models for detecting abnormalities are described in greater detail above with reference to FIG. 7.

Abnormality identifier 716 is also shown to include a business logic module 1206. Business logic module 1206 can perform an analysis to incorporate business logic to further ensure that vibration data sets are not indicative of building equipment faults. Business logic module 1206 can account for business logic that may need to be considered before a vibration data set can be automatically labeled. Business logic module 1206 can analyze a single set of data (e.g., a set of abnormality probabilities) with the context of past analysis results for data set abnormality controller 700. If the current data is acceptable/normal, but the previous set of data was not normal, additional care may need to be taken with how the data is communicated to the end customer and how vibration data sets are analyzed. For example, business logic module 1206 may account for questions such as, “were any repairs performed” or “were there any changes in operating conditions.” If, for example, a previous vibration data set was labeled as abnormal and a current vibration data set is so far normal (e.g., as indicated by maximum probability identifier 1202 and/or abnormality model 1204) but no maintenance has occurred, further analysis may be required. In this case, analysis may be useful to determine why vibrational data has changed from appearing abnormal to appearing normal. Other business logic that can be accounted for by business logic module 1206 may include, for example, changes to how customers desire vibration data sets to be labeled, if any operation conditions have changed, etc.

Abnormality identifier 716 is also shown to include a model auditor 1208. Model auditor 1208 can performed an auditing process to test performance of abnormality model 1204. Model auditor 1208 may test performance of abnormality model 804 periodically, after a certain amount of vibration data sets are analyzed, responsive to a user/analyst request for auditing, etc.

In some embodiments, model auditor 1208 may perform the model auditing process in response to determining that a vibration data set has been approved by abnormality model 1204 (e.g., determined to be normal) and has passed a business logic test performed by business logic module 1206, but that it was flagged for audit. Based on the audit flag, model auditor 1208 can go back and have the vibration data set analyzed by an analyst. If the vibration data set passes human analysis, then model auditor 1208 may determine abnormality model 1204 worked correctly. However, if the vibration data set fails the human analysis process (i.e., the analyst indicates the vibration data set is abnormal), then abnormality model 1204 should be reviewed.

It should be noted that the auditing performed by model auditor 1208 should take place after the business logic test performed by business logic module 1206, because if the business logic test fails, then the human analysis result might differ for reasons not related to the current set of data, which is not tested for. It should also be noted that, if abnormality model 1204 is not used to label vibration data sets (e.g., if maximum probability identifier 1202 is used to label vibration data sets), model auditor 1208 may or may not be a component of abnormality identifier 716. Components of abnormality identifier 716 shown in FIG. 12 are provided purely for sake of example. Abnormality identifier 716 can include any relevant components for performing abnormality identification of abnormality probabilities for vibration data sets.

Model reasoning generator 1210 can be configured to generate model reasoning 1218. As noted above, model reasoning 1218 may indicate the specific reason or reasons why a certain label was applied or may indicate specific portions of the vibration data set that led to the label being applied by abnormality model 1204. Model reasoning 1218 may provide insight into the operation of abnormality model 1204 to allow a user to understand why certain labels were applied and readily identify the relevant data for human analysis. Examples of model reasoning 1218 may indicate a particular sensor from which abnormal data was received (e.g., “Vibration Sensor ABC”), a particular time period of the sensor data determined to be abnormal (e.g., “May 7, 2024,” “2024 May 7 between 10:00 AM and 11:00 AM”), a particular reason why the sensor data was determined to be abnormal (e.g., a rule or business logic that was triggered to flag the vibration data as abnormal), a particular portion of the FFT spectra that was determined to be abnormal (e.g., “FFT amplitude greater than threshold at X Hz”), or any other type of reasoning or explanation providing additional insight into the applied label.

Referring now to FIGS. 13-15, several graphs 1300, 1400, and 1500 illustrating FFT spectra generated by data set preparation module 712 for a given set of vibration data are shown, according to an exemplary embodiment. Graphs 1300, 1400, and 1500 may be included in the customer report generated by report generator 718. Graph 1300 illustrates a scenario in which model reasoning 1218 is not included, whereas graphs 1400 and 1500 illustrate a scenario in which model reasoning 1218 is included.

In graph 1300, spectral data 1304 is shown for several points 1302. Each of points 1302 may represent data generated by a particular sensor. In the example shown in FIG. 13, points 1302 include nine different points collected by nine different sensors labeled MOV, MOH, MOA, CIV, CIH, CIA, COV, COH, and COI. In some embodiments, the nine points 1302 shown in graph 1300 represent vibration data collected in three sensor orientations (e.g., X, Y, and Z directions of three-dimensional space) at three different locations (e.g., a compressor, an off-end motor, and a drive-end motor) resulting in nine sets of timewave data and nine corresponding FFT spectra 1304. In this example, the spectral data associated with the MOV point 1302 was identified as abnormal by abnormality identifier 716, but such information is not included in graph 1300. Without model reasoning 1218, graph 1300 does not provide any indication of which of the nine points 1302 caused the abnormal label to be applied.

In graph 1400, spectral data 1404 is shown for only the MOV point 1402 identified as abnormal by abnormality identifier 716, whereas the other eight points 1302 are hidden. This type of model reasoning 1218 may identify the particular point (i.e., MOV point 1402) which caused abnormality identifier 716 to apply the abnormal label to the vibration data set including data for all nine points 1302. In this way, abnormality identifier 716 can help focus the human analyst on the particular point that led to the abnormal classification. Graph 1500 provides another example of spectral data 1502 along with a textual explanation 1504 of the equipment status (i.e., “abnormal”) and the model reasoning 1218. The model reasoning 1218 is shown as “Anomaly is detected in MOV. The non-synchronous peak has higher amplitude.”). This type of model reasoning 1218 both identifies the particular point (i.e., MOV point 1402) which caused abnormality identifier 716 to apply the abnormal label and provides a reason why the data was classified as abnormal (i.e., “The non-synchronous peak has higher amplitude”).

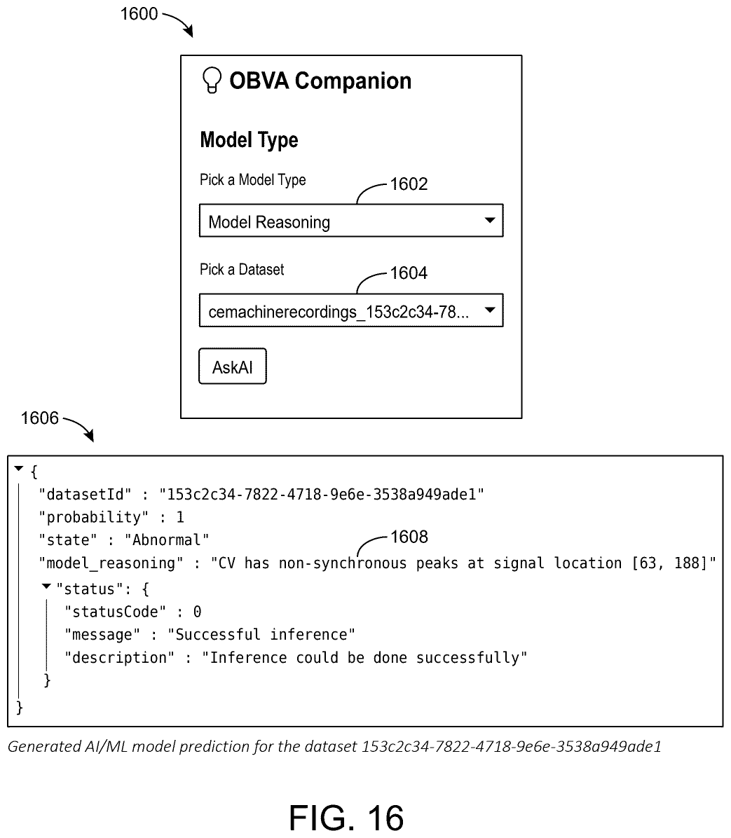

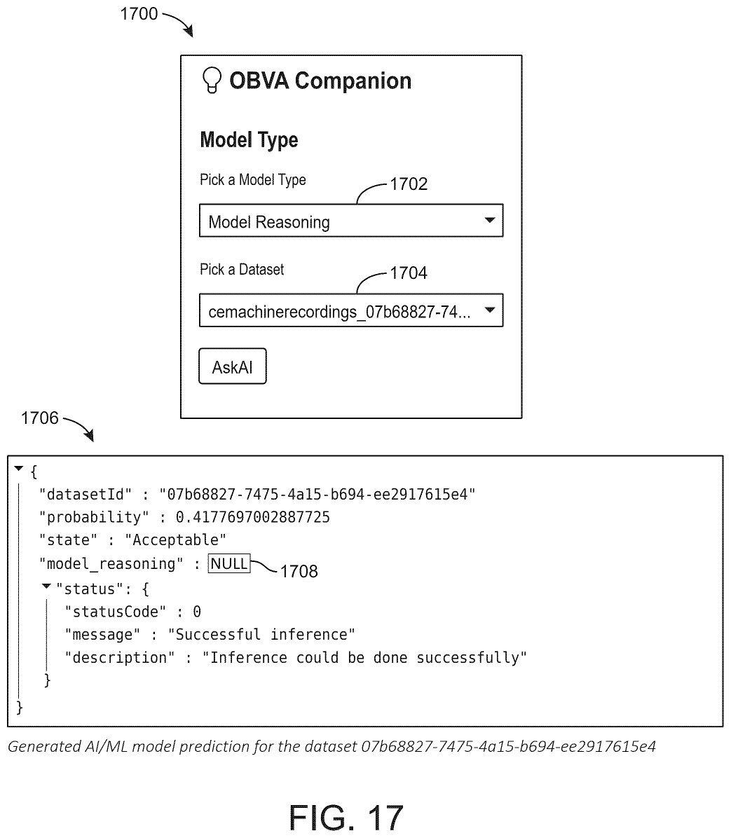

Referring now to FIG. 16-17, two interfaces 1600 and 1700 which can be generated by data set abnormality controller 700 are shown, according to exemplary embodiments. Interfaces 1600 and 1700 may be presented to a user via a user device 724 and/or included in the customer report generated by report generator 718. Both interfaces 1600 and 1700 are shown to include selectors 1602 and 1702 which allow a user to select a particular type of model used to analyze the dataset received from building equipment 720. In both interfaces 1600 and 1700, the user has selected “model reasoning” indicating that the output of abnormality model 1204 will include model reasoning 1218. Both interfaces 1600 and 1700 are also shown to include selectors 1604 and 1704 which allow a user to select a particular dataset received from building equipment 720.

Interfaces 1600 and 1700 are shown to include model output windows 1606 and 1706. In the embodiments shown in FIGS. 16-17, model output windows 1606 and 1706 are shown as data objects having various attributes (e.g., dataset ID, probability, state, model reasoning, status, status code, message, description, etc.). The dataset ID attribute may identify the particular dataset selected via selectors 1604 and 1704. The probability attribute may indicate the abnormality probability generated by ML models 714. The state attribute may indicate the label generated or applied by abnormality identifier 716 (e.g., normal, abnormal, acceptable, vibration, no vibration, etc.). The model reasoning attribute may include the content of model reasoning 1218 generated by model reasoning generator 1210. In interface 1600, the model reasoning attribute 1608 is shown as “CV has non-synchronous peak at signal location [63, 188]” which indicates both the particular point (i.e., “CV”) and the particular reason why that point was classified as abnormal (i.e., “non-synchronous peak at signal location [63, 188]”). In interface 1700, the model reasoning attribute 1708 is shown as “null” because the corresponding model state is “acceptable” indicating that no abnormalities were identified in the selected dataset. While model output windows 1606 and 1706 are shown as data objects in interfaces 1600 and 1700, it is contemplated that other formats could be used to present some or all of the same information shown in model output windows 1606 and 1706.

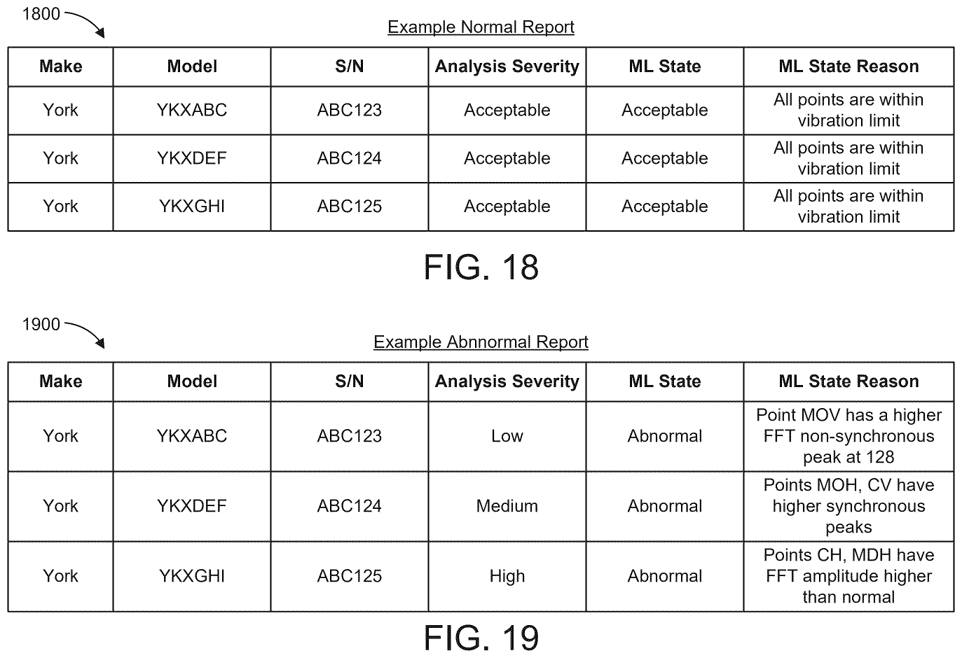

Referring now to FIGS. 18-19, examples of tables 1800 and 1900 which can be generated by data set abnormality controller 700 are shown, according to exemplary embodiments. Tables 1800 and 1900 are examples of another format in which the output of abnormality identifier 716 can be presented. In some embodiments, tables 1800 and 1900 may be presented to a user via a user device 724 and/or included in the customer report generated by report generator 718. Both tables 1800 and 1900 are shown to include rows corresponding to particular devices of building equipment 720 and columns corresponding to attributes of the building equipment 720 and/or outputs generated by abnormality identifier 716.

Some attributes shown in tables 1800 and 1900 may be populated using the information received from building equipment 720 and/or from the information extracted from enterprise documents 1004. For example, the “make” column, “model” column, and serial number “S/N” column may be populated with the equipment-specific attributes of building equipment 720 included in a given system or building. The values of these attributes may be constant regardless of how building equipment 720 are performing. Conversely, other attributes shown in tables 1800 and 1900 may be populated using the outputs generated by abnormality identifier 716. For example, the “analysis severity” column and the “ML state” column may be populated with the labels generated and applied by abnormality identifier 716. The “ML state reason” column may be populated with the model reasoning 1218 generated by model reasoning generator 1210.

In table 1800, the outputs generated by abnormality identifier 716 indicate the corresponding vibration datasets for a set of three chillers were classified as acceptable. For example, both the “analysis severity” column and the “ML state” column include values of “acceptable” indicating no abnormality or an acceptable level of abnormality (e.g., below a threshold) was detected in the vibration datasets. The “ML state reason” column indicates the model reasoning 1218 indicating why the “acceptable” label was applied to the vibration datasets. The model reasoning 1218 is shown as “all points are within vibration limit.”

Conversely, in table 1900, the outputs generated by abnormality identifier 716 indicate the corresponding vibration datasets for a set of three chillers were classified as abnormal. For example, the “ML state” column includes values of “abnormal” indicating abnormalities were detected in the vibration datasets. The “analysis severity” column indicates the degrees of the abnormalities, shown as “low,” “medium,” and “high.” The “ML state reason” column indicates the model reasoning 1218 indicating why the “abnormal” label was applied to the vibration datasets. The model reasoning 1218 is shown as “Point MOV has a higher FFT non-synchronous peak at 128” for the first row, “Points MOH, CV have higher synchronous peaks” for the second row, and “Points CH, MDH have FFT amplitude higher than normal” for the third row. These examples of model reasoning 1218 indicate both the particular points determined to have abnormal vibration data (i.e., MOV, MOH, CV, CH, and MDH) and the particular reasons why those points were classified as abnormal (i.e., “higher FFT non-synchronous peak at 128,” “higher synchronous peaks,” and “FFT amplitude higher than normal”).

In some embodiments, abnormality identifier 716 can classify an abnormality into various degrees of severity such as “alert,” “alarm,” and “danger” which indicate progressively more severe abnormalities. The severity can be indicated in tables 1800-1900 as the analysis severity and/or the ML state in various embodiments, or as a new attribute or label in addition to the labels shown in tables 1800-1900. For example, abnormality identifier 716 can be configured to label a data set with a first label indicating whether the data set is normal or abnormal and, if the data set is labeled as abnormal, with a second label indicating the severity of the abnormality (e.g., “low,” “medium,” or “high;” “alert,” “alarm,” or “danger;” or any other label or set of labels indicating the severity of the abnormality). The severity of the abnormality may dictate the priority of a corrective action performed by data set abnormality controller 700. For example, in response to classifying the abnormality as an “alert” (i.e., a low-severity abnormality) data set abnormality controller 700 may allow building equipment 720 to continue operating under monitoring. However, in response to classifying the abnormality as “alarm” or “danger” (i.e., a medium-severity abnormality or high-severity abnormality) data set abnormality controller 700 may trigger corrective action to address the abnormality immediately.

In some embodiments, abnormality identifier 716 is configured to classify the abnormality as “alert,” “alarm,” or “danger” using a pretrained classification model. The classification model may include one or more machine learning (ML) models or any other type of model configured to classify a severity of the abnormality based on the vibration data set. In various embodiments, the one or more ML models include a separate ML model for each category or label which can be applied (e.g., a first ML model configured to determine whether to label the vibration data as “alert,” a second ML model configured to determine whether to label the vibration data as “alarm,” and a third ML model configured to determine whether to label the vibration data as “danger”), or may include a single ML model configured to select the most relevant label (e.g., “alert,” “alarm,” or “danger”) from a set of multiple labels and apply the selected label to the vibration data set.

Data set abnormality controller 700 can be configured to train the classification model using a set of training data including multiple different vibration data sets and corresponding ground truths (e.g., analyst assessments) indicating the severity of the abnormality associated with each data set. For each set of vibration data provided as training data, data set abnormality controller 700 can use data set preparation module 712 to generate a FFT spectrum of the vibration data set (see FIGS. 13-14 for examples of FFT spectra) and associate the FFT spectrum with the corresponding ground truth indicating the severity of the abnormality. FFT spectra associated with the “alert” category may be relatively close to FFT spectra for “normal” vibration data, whereas FFT spectra associated with the “alarm” and “danger” categories may be progressively more dissimilar or further from the “normal” FFT spectra. The training process may include training the classification model to generate and apply an “alert,” “alarm,” or “danger” label to a set of vibration data based on how closely the vibration data (e.g., the raw vibration data and/or the FFT spectrum generated from the raw vibration data) match the training data associated with each label.

In some embodiments, data set abnormality controller 700 may include some or all of the components and/or may be configured to perform some or all of the processes described in U.S. Pat. No. 11,070,389 granted Jul. 20, 2021, U.S. Pat. No. 11,156,996 granted Oct. 26, 2021, and/or U.S. Pat. No. 11,422,547 granted Aug. 23, 2022, the entire disclosure of each of which is incorporated by reference herein. It is contemplated that any combination of features selected from the present disclosure and/or any of the patents or patent applications incorporated by reference herein can be included in data set abnormality controller 700 in various embodiments.

### Processes

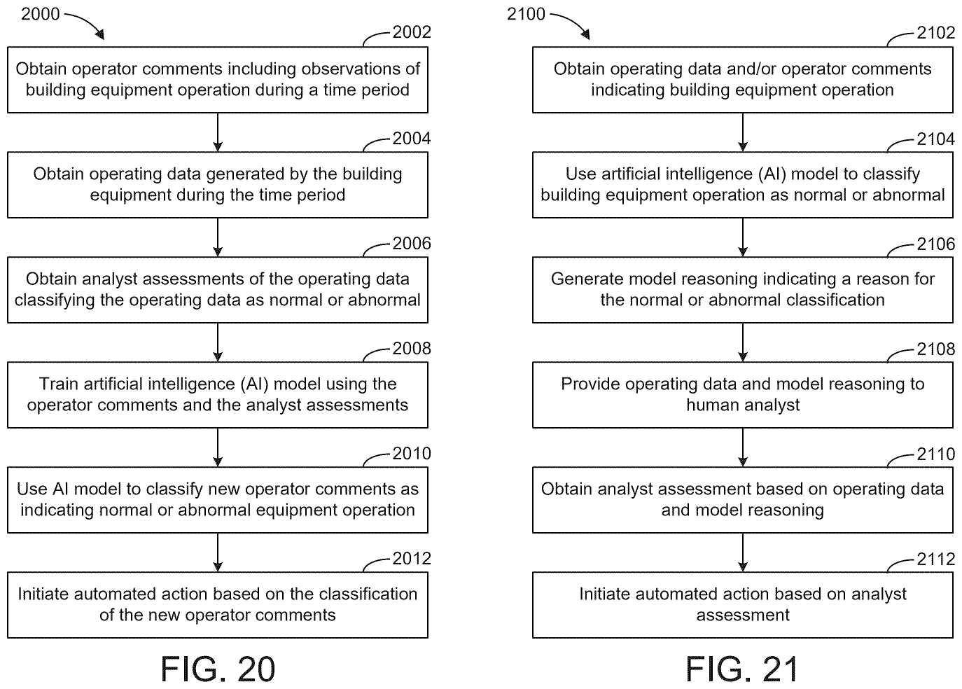

Referring now to FIG. 20, a flowchart of a process 2000 for correcting anomalous operation of building equipment is shown, according to an exemplary embodiment. In some embodiments, process 2000 is performed by data set abnormality controller 700 or various components thereof, as described with reference to FIGS. 7-19. Process 2000 can be performed to train an artificial intelligence model (e.g., fine-tuned LLM 906, LLM 1010) to classify operator comments 902 characterizing the operation of building equipment 720. In some embodiments, process 2000 is initiated automatically (e.g., performed in response to detecting predetermined triggers, periodically at predetermined intervals, etc.) or can be executed on demand (e.g., in response to a request from a user or automated system).

Process 2000 is shown to include obtaining operator comments including observations of building equipment operation during a time period (step 2002). In some embodiments, operator comments (e.g., operator comments 902) are received from an operator device 721. Operator device 721 may include any type of user device capable of receiving input from an operator (e.g., a human, a service technician, a maintenance worker, an equipment installer, a building owner, a building occupant, etc.) regarding the observed performance of building equipment 720. Examples of operator devices 721 include a smartphone, a laptop computer, a tablet, a desktop computer, or any other device which can be used to obtain operator comments from the operator. Operator comments may include the operator's observations, notes, assessments, or other comments from the operator indicating the operator's personal assessment of building equipment 720 (e.g., upon inspection, upon observation, etc.). Examples of operator comments include comments such as “motor sounds rough when running,” “technician has noted noise after a few minutes of machine operation,” “extremely noisy,” “motor was shaking extremely,” “noted motor running with unpleasant humming noise,” “everything looks okay,” “new coupling,” “chiller is leaking fluid,” “surface hot to the touch,” or any other comment the operator chooses to provide regarding building equipment 720.

Operator comments can be provided in a variety of different formats or modalities (e.g., text, speech, audio, image, and/or video). Operator comments can include unstructured data or structured data. Unstructured data may include data that does not conform to a predetermined format or data that conforms to a plurality of different predetermined formats. For example, the unstructured data may include freeform data that does not conform to any particular format (e.g., freeform text, natural language text, or other freeform data) and/or data that conforms to a combination of different predetermined formats (e.g., a text format, a speech format, an audio format, an image format, a video format, a data file format, etc.). In some embodiments, the unstructured data includes multi-modal data provided by different types of sensory devices (e.g., an audio capture device, a video capture device, an image capture device, a text capture device, a handwriting capture device, etc.). Conversely, structured data may include data that conforms to a predetermined format. In some embodiments, structured data includes data that is labeled with or assigned to one or more predetermined fields or identifiers. For example, the structured data may conform to a structured data format including one or more predetermined fields or locations and one or more predetermined labels or identifiers characterizing the one or more predetermined fields or locations. In some embodiments, operator comments can include any of the various types of service data, service reports, and/or data sources described in U.S. patent application Ser. No. 18/633,068 filed Apr. 11, 2024, the entire disclosure of which is incorporated by reference herein.

In some embodiments, step 2002 includes storing the operator comments in a database (e.g., database 726). Step 2002 may include identifying the particular sensor or device of building equipment 720 described by each of the operator comments and storing such information along with the operator comments in database 726. In various embodiments, step 2002 may include identifying the particular sensor or device of building equipment 720 described by each of the operator comments based on information included in the operator comments themselves or auxiliary information or metadata included with the operator comments. Such information may include the locations of operator devices 721 (e.g., GPS coordinates, triangulated locations, etc.) when the operator comments are entered relative to the locations of building equipment 720 (e.g., associating operator comments with the nearest building equipment 720), selections made by the operator when entering the operator comments (e.g., selecting particular devices of building equipment 720), information extracted from work orders or maintenance tasks assigned to the operator during a time period when the operator comments are entered (e.g., a work order specifying the operator is assigned to inspect a particular device of building equipment 720 at the time the operator comments are entered), or any other association or link which can be used to match or associate a particular operator comment with a corresponding device of building equipment 720. In some embodiments, step 2002 may include using any of the techniques described in U.S. patent application Ser. No. 18/633,068 filed Apr. 11, 2024, the entire disclosure of which is incorporated by reference herein, to associate the operator comments with corresponding building equipment 720 and/or other data sources.

Process 2000 is shown to include obtaining operating data generated by the building equipment during the time period (step 2004). Operating data may include timeseries data (e.g., temporal data) provided by building equipment 720 (e.g., sensors, chillers, boilers, fans, pumps, lighting equipment, controllers, etc.). For example, operating data may include timeseries of measurements from one or more sensors (e.g., vibration sensors, temperature sensors, humidity sensors, audio sensors, etc.), timeseries of setpoints or control signals provided to building equipment 720 or from building equipment 720, timeseries of internal states of building equipment 720 (e.g., internal variables stored and updated within building equipment 720), or any other type of operating data generated by building equipment 720. In some embodiments, the operating data include vibration data sets measured by one or more vibration sensors attached to building equipment 720 or otherwise positioned to measure vibration of building equipment 720. In some embodiments, the operating data include measurements from sensors that measure a variable state or condition affected by building equipment 720. For example, if building equipment 720 are chillers, boilers, or air handling units that serve a particular building space, the operating data may include measurements of the temperature of the building space.

In some embodiments, step 2004 includes storing the operating data in a database (e.g., database 726). In some embodiments, step 2004 includes associating the operating data with corresponding operator comments and storing such associations in database 726. For example, step 2004 can include identifying the particular sensor or device of building equipment 720 that provides the operating data and storing an indication of the source of the operating data along with the operating data in database 726. In some embodiments, step 2004 may include using any of the techniques described in U.S. patent application Ser. No. 18/633,068 filed Apr. 11, 2024, the entire disclosure of which is incorporated by reference herein, to associate the operating data with corresponding building equipment 720, the operator comments received in step 2002, and/or other data sources. In some embodiments, the associations generated in step 2004 are based on the time period during which the operating data are collected and the corresponding time periods when the operator comments are entered.

Process 2000 is shown to include obtaining analyst assessments of the operating data classifying the operating data as normal or abnormal (step 2006). The analyst assessments (e.g., analyst assessments 910) can be provided by one or more analyst devices 722 and may indicate whether the operating data are normal or abnormal in the opinion of the analyst. In various embodiments, the analyst may be a human expert tasked with evaluating the operating data for abnormalities or an artificial intelligence model capable of classifying the operating data as normal or abnormal using any of systems or methods described throughout the present disclosure.

In some embodiments, step 2006 includes storing the analyst assessments in a database (e.g., database 726). In some embodiments, step 2006 includes associating the analyst assessments with corresponding operating data and/or corresponding operator comments and storing such associations in database 726. For example, step 2006 can include identifying the set of operator comments corresponding to the analyst assessments and storing associations between the operator comments and the analyst assessments in database 726. In some embodiments, the operator comments and analyst assessments are associated if they both pertain to the same set of operating data. In some embodiments, step 2006 may include using any of the techniques described in U.S. patent application Ser. No. 18/633,068 filed Apr. 11, 2024, the entire disclosure of which is incorporated by reference herein, to associate the analyst assessments with the operator comments received in step 2002, the operating data received in step 2004, and/or other data sources.

Process 2000 is shown to include training an artificial intelligence (AI) model using the operator comments and the analyst assessments (step 2008). In some embodiments, step 2008 includes training operator comment classifier 713 using any of the techniques described throughout the present disclosure. Step 2008 may include training operator comment classifier 713 to learn a relationship between the operator comments and the corresponding analyst assessments. For example, if a certain word or phrase in the operator comments (e.g., “excessive noise”) is correlated with analyst assessments that indicate the corresponding operating data are abnormal, step 2008 may include training operator comment classifier 713 to associate such operator comments with the operating data being abnormal. Conversely, if a certain word or phrase in the operator comments (e.g., “everything appears normal”) is correlated with analyst assessments that indicate the corresponding operating data are normal, step 2008 may include training operator comment classifier 713 to associate such operator comments with the operating data being normal.

In various embodiments, the AI model trained in step 2008 may include a few-shot classifier (transformer) as shown in FIG. 11, a large language model (LLM) as shown in FIGS. 9-10 (e.g., fine-tuned LLM 906 or LLM 1010), or any combination thereof. In some embodiments, the AI model trained in step 2008 includes a generative artificial intelligence (GAI) model such as a GPT model. The GPT model can be configured to generate a response to a user query as shown in FIG. 10, using any of the techniques described with reference to operator comment classifier 713 or other types of GPT models described throughout the present disclosure. The AI model can be trained using a set of training data including any of the operator comments obtained in step 2002, any of the operating data obtained in step 2004, and/or any of the analyst comments obtained in step 2006. The set of training data may be associated with a first time period during which the operator comments in step 2002 and operating data in step 2004 are generated. The AI model can be trained to predict the analyst assessments that would be applied to the operator comments.

Process 2000 is shown to include using the AI model to classify new operator comments as indicating normal or abnormal equipment operation (step 2010). The new operator comments may be received during a second time period occurring after the time period referenced in steps 2002 and 2004. The new operator comments in step 2010 may be similar to the operator comments obtained in step 2002, with the exception that the new operator comments in step 2010 are not yet associated with corresponding analyst assessments and are not used to train the AI model. Accordingly, the new operator comments received in step 2010 are not yet classified as indicating normal or abnormal equipment operation. Step 2010 may include providing the new operator comments as inputs to the AI model trained in step 2008 to generate classifications (e.g., comment classifications 912, comment classifications 1214) for each of the operator comments. The classifications may be provided as outputs of the AI model.

In some embodiments, step 2010 includes providing a plurality of input labels (e.g., input labels 1102) as inputs to the AI model and classifying the operator comments into categories defined by the input labels. For example, for operator comments associated with a set of vibration data, the input labels may include labels such as “vibration,” “no vibration,” and “unknown” as shown in FIG. 11. The input labels which can be specified by a user or automatically generated by the AI model. In some embodiments, step 2010 includes providing a user interface (e.g., interface 1100) which allows a user to enter any number of input as the categories into which the operator comments will be classified. Input labels can be specified in any of a variety of ways including entering the text of input labels via the user interface, selecting input labels from a pre-populated list of potential input labels, or using the AI models to automatically generate or suggest input labels based on the type of data being classified (e.g., vibration, temperature, pressure, etc.) and/or content of the operator comments.

Process 2000 is shown to include initiating an automated action based on the classification of the new operator comments (step 2012). In some embodiments, the automated action includes applying an “abnormal” label or classification to the operating data corresponding to the operator comments in response to the AI model classifying the operator comments as abnormal (i.e., indicating an abnormality). In some embodiments, step 2012 include applying one or more of the input labels specified in step 2010 to the operating data based on the classifications of the corresponding operator comments. Step 2012 may include applying a label or classification to the operating data as well as a probability that the applied label or classification is correct. In some embodiments, step 2012 includes using the AI model to determine a probability for each of the input labels under consideration and applying the input label with the highest probability to the set of operating data.

In some embodiments, the automated action in step 2012 is performed in response to the classification in step 2010 classifying the new operator comments as normal (i.e., not indicating an abnormality). For example, the automated action in step 2012 may include using one or more machine learning (ML) models (e.g., ML models 714) to evaluate the operating data in response to classifying the operator comments as normal in step 2010. Using ML models 714 to evaluate the operating data may include preparing the operating data for input into ML models 714 (e.g., generating FFT spectra for vibration data, formatting the operating data into the format used by ML models 714, etc.) as described with reference to data set preparation module 712. Step 2012 may include using ML models 714 to determine abnormality probabilities for each set of operating data using any of the techniques described with reference to ML models 714.

In some embodiments, the automated action in step 2012 includes using abnormality identifier 716 to label the operating data as normal, abnormal, or with any other label based on the set of abnormality probabilities generated by ML models 714 and/or the comment classifications generated by operator comment classifier 713. In some embodiments, the automated action in step 2012 includes generating model reasoning (e.g., model reasoning 1218) indicating the specific reason or reasons why a certain label was applied or indicating specific portions of the operating data that led to the label being applied. The model reasoning may provide insight into the operation of abnormality identifier 716 to allow a user to understand why certain labels were applied and readily identify the relevant data for human analysis.

In some embodiments, the automated action in step 2012 includes generating a customer report. The customer report can be generated by report generator 718, as described with reference to FIG. 7. If the operator comments are classified as normal in step 2010 and/or the corresponding operating data are classified as normal by ML models 714, the report generated in step 2012 may be a “normal” report as shown in FIG. 18. However, if the operator comments are classified as abnormal in step 2010 and/or the corresponding operating data are classified as abnormal by ML models 714, the report generated in step 2012 may be an “abnormal” report as shown in FIG. 19. The normal report may indicate that the operating data are normal or acceptable and may include a reason why the normal classification was applied (e.g., the ML state reasons shown in FIG. 18). Conversely, abnormal report may indicate that the operating data are abnormal and may include a reason why the abnormal classification was applied (e.g., the ML state reasons shown in FIG. 19).

In some embodiments, the automated action in step 2012 includes initiating a corrective action. A corrective action may be initiated in response to classifying the operator comments as abnormal in step 2010 and/or in response to ML models 714 classifying the corresponding operating data as abnormal. Some types of corrective actions include providing the abnormal data set to report generator 718 to generate a report detailing the abnormality or alerting a user of user device 724 that abnormality may be present. Other types of corrective actions which can be initiated in step 2012 include maintenance, replacement, and/or other repairs of building equipment 720. For example, a specific building device of building equipment 720 may be scheduled to be replaced based on the operator comments being classified as abnormal in step 2010 and/or ML models 714 classifying the corresponding operating data as abnormal. Corrective actions may be initiated by the analyst via analyst device 722, automatically by abnormality identifier 716, and/or another component of data set abnormality controller 700, and/or by any other entity authorized to initiate corrective actions.

In some embodiments, step 2012 includes initiating a corrective action upon identifying the operating data or operator comments as abnormal. Providing the operating data to an analyst is one example of a corrective action which can be initiated in step 2012. In some embodiments, the corrective action in step 2012 may be selected from a first subset of corrective actions which can be taken prior to confirming abnormality with an analyst. The first subset of corrective actions may be less significant or impactful in an effort to avoid substantial changes to the building equipment in the absence of confirmation from the analyst. However, upon the analyst confirming the abnormality, the corrective action in step 2012 may be selected from a second subset of corrective actions which can be performed only upon the feedback from the analyst (e.g., the analyst assessment) confirming the abnormality. The second subset of corrective actions may be more significant or impactful than the first set of corrective actions and can be implemented in response to the feedback from the analyst confirming the abnormality.

Referring now to FIG. 21, a flowchart of a process 2100 for correcting anomalous operation of building equipment is shown, according to an exemplary embodiment. In some embodiments, process 2100 is performed by data set abnormality controller 700 or various components thereof, as described with reference to FIGS. 7-19. Process 2100 can be performed for classify building equipment operation as normal or abnormal using an artificial intelligence model (e.g., ML models 714) and generate model reasoning indicating a reason for the normal or abnormal classification. In some embodiments, process 2100 is initiated automatically (e.g., performed in response to detecting predetermined triggers, periodically at predetermined intervals, etc.) or can be executed on demand (e.g., in response to a request from a user or automated system.

Process 2100 is shown to include obtaining operating data and/or operator comments indicating building equipment operation (step 2102). The operator comments obtained in step 2102 may be the same as or similar to the operator comments obtained in step 2002 of process 2000. For example, operator comments may include the operator's observations, notes, assessments, or other comments from the operator indicating the operator's personal assessment of building equipment 720 (e.g., upon inspection, upon observation, etc.). Similarly, the operating data obtained in step 2102 may be the same as or similar to the operating data obtained in step 2004 of process 2000. For example, operating data may include timeseries data (e.g., temporal data) provided by building equipment 720 (e.g., sensors, chillers, boilers, fans, pumps, lighting equipment, controllers, etc.).

Process 2100 is shown to include using an artificial intelligence (AI) model to classify the building equipment operation as normal or abnormal (step 2104). The AI model may include one or more components of operator comment classifier 713 (e.g., fine-tuned LLM 906, LLM 1010), ML models 714, and/or abnormality identifier 716 (e.g., abnormality model 1204) as described with reference to FIGS. 7-19. The AI model used in step 2104 may receive as an input the operator comments and/or operating data received in step 2102 and may output the comment classifications (e.g., as an output of operator comment classifier 713), the abnormality probabilities (e.g., as an output of ML models 714), and/or the labeled data set (e.g., as an output of abnormality identifier 716) as shown in FIG. 7. Step 2104 can include any of the features, functions, or steps performed by operator comment classifier 713, ML models 714, abnormality identifier 716, or other components of data set abnormality controller 700, as described throughout the present disclosure.

Process 2100 is shown to include generating model reasoning indicating a reason for the normal or abnormal classification (step 2106). In some embodiments, the model reasoning (e.g., model reasoning 1218) is generated by abnormality identifier 716 or various components thereof (e.g., model reasoning generator 1210), as described with reference to FIGS. 7-19. The model reasoning may indicate the specific reason or reasons why a certain label was applied or indicating specific portions of the operating data that led to the label being applied. The model reasoning may provide insight into the operation of abnormality identifier 716 to allow a user to understand why certain labels were applied and readily identify the relevant data for human analysis.

Process 2100 is shown to include providing operating data and model reasoning to a human analyst (step 2108). In some embodiments, step 2108 is performed by abnormality identifier 716 and/or report generator 718 as described with reference to FIGS. 7-19. The operating data may be provided in the form of a customer report including the operating data, any derivations of the operating data (e.g., FFT spectra), the operator comments, the labels or classifications applied to the operating data or operator comments, and/or the model reasoning explaining why certain labels were applied to the operating data and/or operator comments. Examples of outputs which can be provided in step 2108 are shown in FIGS. 13-19.

Process 2100 is shown to include obtaining an analyst assessment based on the operating data and model reasoning (step 2110) and initiating an automated action based on analyst assessment (step 2112). The analyst assessments can be provided by one or more analyst devices 722 and may indicate whether the operator comments and/or the operating data are normal or abnormal in the opinion of the analyst. The analyst assessments can be provided as feedback to data set abnormality controller 700 and may be associated with corresponding sets of operating data and/or operator comments in database 726. The automated action initiated in step 2112 may include any of the automated actions initiated in step 2012 of process 2000, as previously described.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A method for correcting abnormal operation of equipment, the method comprising:
obtaining a vibration data set comprising vibration measurements recorded by one or more vibration sensors while operating the equipment during a time period;
obtaining operator comments comprising observations from an operator characterizing operation of the equipment during the time period;
analyzing the vibration data set and the operator comments using one or more machine learning models to identify the operation of the equipment as normal or abnormal; and
initiating a corrective action responsive to identifying the operation of the equipment as abnormal.

2. The method of claim 1, wherein the operator is a human and the operator comments comprise human observations of the operation of the equipment during the time period.

3. The method of claim 1, wherein analyzing the operator comments comprises classifying the operator comments using the one or more machine learning models to generate comment classifications indicating normal or abnormal operation of the equipment as an output of the one or more machine learning models.

4. The method of claim 1, wherein analyzing the operator comments comprises:
receiving a plurality of input labels defining a set of classifications for the operator comments; and
classifying the operator comments into the set of classifications using the one or more machine learning models.

5. The method of claim 1, wherein analyzing the vibration data set comprises:
performing one or more fast Fourier transforms on the vibration data set to generate one or more fast Fourier transform (FFT) spectra; and
providing the one or more FFT spectra as input to the one or more machine learning models to generate one or more abnormality probabilities as an output of the one or more machine learning models.

6. The method of claim 1, comprising training the one or more machine learning models by performing a model training process comprising:
obtaining a training set of operator comments comprising observations from one or more operators characterizing the operation of the equipment or other equipment during a training period prior to the time period;
obtaining a training set of analyst assessments classifying the operation of the equipment or the other equipment during the training period into one or more categories; and
training the one or more machine learning models to learn a relationship between the training set of operator comments and the training set of analyst assessments.

7. The method of claim 1, wherein the one or more machine learning models comprise a large language model (LLM), the method comprising:
receiving a user query pertaining to the operation of the equipment during the time period;
generating a response to the user query using the LLM, the response comprising text generated by the LLM based on the vibration data set and the operator comments; and
providing the response to the user query to a user device.

8. The method of claim 1, wherein the corrective action comprises at least one of:
scheduling maintenance or replacement for the equipment;
generating an abnormal report describing the abnormal operation of the equipment; or
disabling the equipment or adjusting the operation of the equipment.

9. A method for correcting abnormal operation of equipment, the method comprising:
obtaining a vibration data set comprising vibration measurements recorded by one or more vibration sensors while operating the equipment during a time period;
analyzing the vibration data set using one or more machine learning models to identify the operation of the equipment as normal or abnormal;
generating model reasoning indicating a reason why the operation of the equipment is identified as normal or abnormal by the one or more machine learning models; and
initiating a corrective action responsive to identifying the operation of the equipment as abnormal, the corrective action based on the model reasoning.

10. The method of claim 9, comprising:
providing the vibration data set and the model reasoning to a human analyst;
receiving feedback from the human analyst indicating whether the operation of the equipment is normal or abnormal based on the vibration data set and the model reasoning; and
initiating the corrective action responsive to the feedback from the human analyst indicating the operation of the equipment is abnormal.

11. The method of claim 9, comprising:
using the model reasoning to identify a subset of the vibration data set that caused the one or more machine learning models to identify the operation of the equipment as abnormal; and
providing the subset of the vibration data set and the model reasoning to a human analyst.

12. The method of claim 9, wherein:
the vibration data set comprises measurements recorded by a plurality of vibration sensors while operating the equipment during the time period; and
the model reasoning comprises an indication of a subset of the vibration data recorded by a particular vibration sensor of the plurality of vibration sensors that caused the one or more machine learning models to identify the operation of the equipment as abnormal.

13. The method of claim 9, wherein:
analyzing the vibration data set comprises performing one or more fast Fourier transforms on the vibration data set to generate one or more fast Fourier transform (FFT) spectra; and
the model reasoning comprises an indication of a subset of the FFT spectra that caused the one or more machine learning models to identify the operation of the equipment as abnormal.

14. The method of claim 9, comprising generating a report comprising:
a particular state of the equipment selected by the one or more machine learning models from a plurality of possible states of the equipment; and
the model reasoning indicating a reason that caused the one or more machine learning models to select the particular state of the equipment from the plurality of possible states of the equipment.

15. The method of claim 9, wherein generating the model reasoning comprises:
analyzing the vibration data set using a set of rules comprising abnormality criteria;
identifying a particular rule of the set of rules for which the abnormality criteria are satisfied by the vibration data set; and
generating a description of the abnormality criteria pertaining to the particular rule.

16. The method of claim 9, wherein the corrective action comprises at least one of:
scheduling maintenance or replacement for the equipment;
generating an abnormal report describing the abnormal operation of the equipment; or
disabling the equipment or adjusting the operation of the equipment.

17. A controller for correcting abnormal operation of equipment, the controller comprising one or more processing circuits configured to:
obtain an operating data set comprising measurements recorded by one or more sensors while operating the equipment during a time period;
obtain operator comments comprising observations from an operator characterizing operation of the equipment during the time period;
analyze the data set and the operator comments using one or more machine learning models to identify the operation of the equipment as normal or abnormal; and
initiate a corrective action responsive to identifying the operation of the equipment as abnormal.

18. The controller of claim 17, wherein analyzing the operator comments comprises classifying the operator comments using the one or more machine learning models to generate comment classifications indicating normal or abnormal operation of the equipment as an output of the one or more machine learning models.

19. The controller of claim 17, wherein analyzing the operator comments comprises:
receiving a plurality of input labels defining a set of classifications for the operator comments; and
classifying the operator comments into the set of classifications using the one or more machine learning models.

20. The controller of claim 17, wherein the one or more processing circuits are configured to train the one or more machine learning models by performing a model training process comprising:
obtaining a training set of operator comments comprising observations from one or more operators characterizing the operation of the equipment or other equipment during a training period prior to the time period;
obtaining a training set of analyst assessments classifying the operation of the equipment or the other equipment during the training period into one or more categories; and
training the one or more machine learning models to learn a relationship between the training set of operator comments and the training set of analyst assessments.
